(19) United States
(12) Patent Application Publication
(10) Pub. No.: US 2004/0142232 A1
(43) Pub. Date: Jul. 22, 2004

(54) Space utilization/component integration using blow molding technology

(76) Inventors: Alex Risca, Troy, MI (US); Andy Puempel, Essex (CA); Bob Burnham, Novi, MI (US); Guy J. Hery, Troy, MI (US); Karim Amellal, Tecumsen (CA); Lou Savoni, LaSalle (CA); Mike Duco, US (US); Mike Ruppert, Rochester Hills, MI (US); Nelson Morren, Allendale, MI (US); Richard Rhodes, Somerworth, NH (US); Roy Watson, Fairfield, CT (US); Steve Hiltner, Ann Arbor, MI (US); Tom Ruden, Farmington, MI (US); Ziggy Baranowski, Farmington, MI (US)

Correspondence Address: Steven J Grossman, Grossman Tucker Perreault & Pfleger, 55 Commercial Street, Manchester, NH, 03101, US

(21) Appl. No.: 10/148,653

(22) PCT Filed: Nov. 30, 2000
(86) PCT No.: PCT/US00/32684

(51) Int. Cl. H01M 2/10

(52) U.S. Cl. 429/100

(57) ABSTRACT

Various plastic structures for automotive applications are disclosed. The plastic structures are preferably produced by blow molding and comprise at least one cavity, generally for containing a vehicle component therein, formed within the confines of the wall structure. Exemplary applications of the plastic structures include various fluid reservoirs located in the engine compartment (e.g. along the fender inner panel, the wheel well liner, the underside of the hood, the cowl, the firewall, and the front-end structure), the passenger compartment (e.g. rear shelf, door arrangements), beneath the vehicle (e.g. fuel tanks, spare tire holders) and alongside the vehicle (e.g. step platforms). Still other applications of the plastic structures include battery holders, cable guides, ducts, filter housings, electrical housings, HVAC housings, a wheel well liner, acoustic resonators, headlamp receptacles, radiator frames, fan shrouds, bumpers, tool platforms, access panels, running boards, step wells, steering wheels, seat frames, mirror housings, spare wheel wells, spare wheel mounting brackets, engine covers, floor pans, engine cowls, and vacuum reservoirs.

The present invention relates to improved space utilization and component integration, preferably using blow molding technology, for automotive or vehicular applications.

In the vehicular environment, there is a continuing need to improve and make more efficient use of vehicular space in areas such as the engine compartment, the passenger seating area and cargo storage areas. The goal, of course, is to provide more advanced interior designs and engineering of the vehicle.

Along such lines, attention is directed to Automotive & Transportation Interiors, November 1999, in an article entitled “Active Lifestyles Drive Storage Systems Development”. As noted therein, innovative storage ideas include a compartment concealed in a hinged rear quarter panel for storing vehicle safety and convenience items, as well as a cargo area that comes with an easy accessible “lazy-Susan” or cargo bins and easy-open drawers. Featured in this article is a description of the Nissan X-Terra as one current vehicle that is said to be responding to changing demands for storage which includes a “backpack pod” designed to accommodate a first aid kit and storage pockets on both the back of the front passenger seat and on the upper left side of the vehicle interior. Storage bins are also included in the cargo area. Among the storage options are an interior bike rack, floor tie-down hooks and ceiling tie-down clips.

With regards to more innovative use of space within the engine compartment, attention is directed to U.S. Pat. No. 5,649,587. As disclosed therein, a compact cooling system structure is employed which eliminates the need for space and fastening means for five separate components in the already crowded engine compartment of today's automobile. The fan shroud thereby comprises a substantial cost savings by virtue of having eliminated the need to manufacture and assemble five separate parts, while utilizing previously unused surface areas of the fan shroud area.

Along such lines, attention is also directed to U.S. Pat. No. 3,692,004 which discloses a fan shroud and fluid storage chamber arrangement. That is, radiator fluid and windshield washer fluid chambers are provided that are integrally molded on opposite side surfaces of the cylindrical wall surrounding the air flow opening.

The present invention relates to a variety of space utilization structures/components for both inside and outside a vehicle. The various embodiments of the present invention are best described with reference to the attached illustrations.

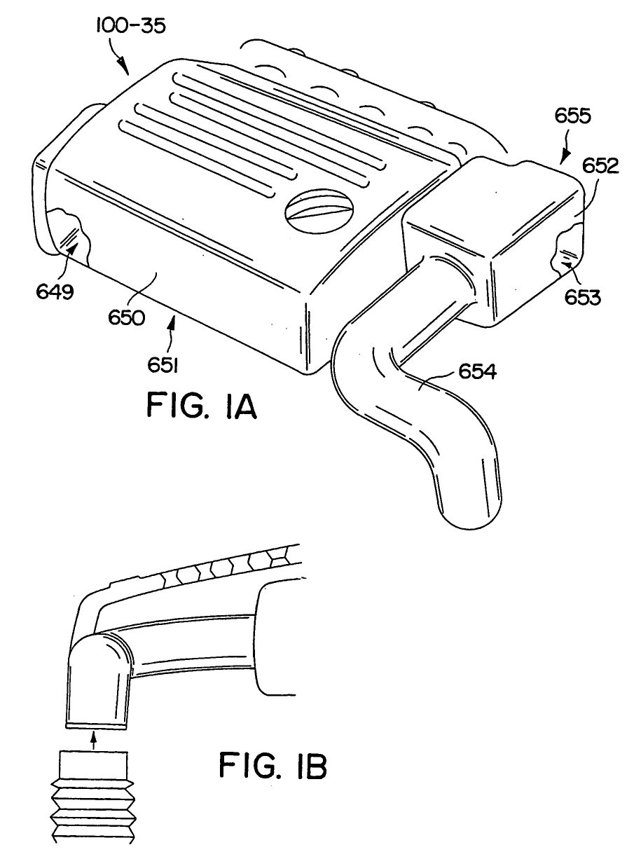

FIG. 1A is a perspective view of a hollow structure 100-35 according to the present invention with cavities 649 and 653 shown in partial cut away view of the wall structure;

FIG. 1B is a partial side view of the hollow structure 100-35 of FIG. 1A;

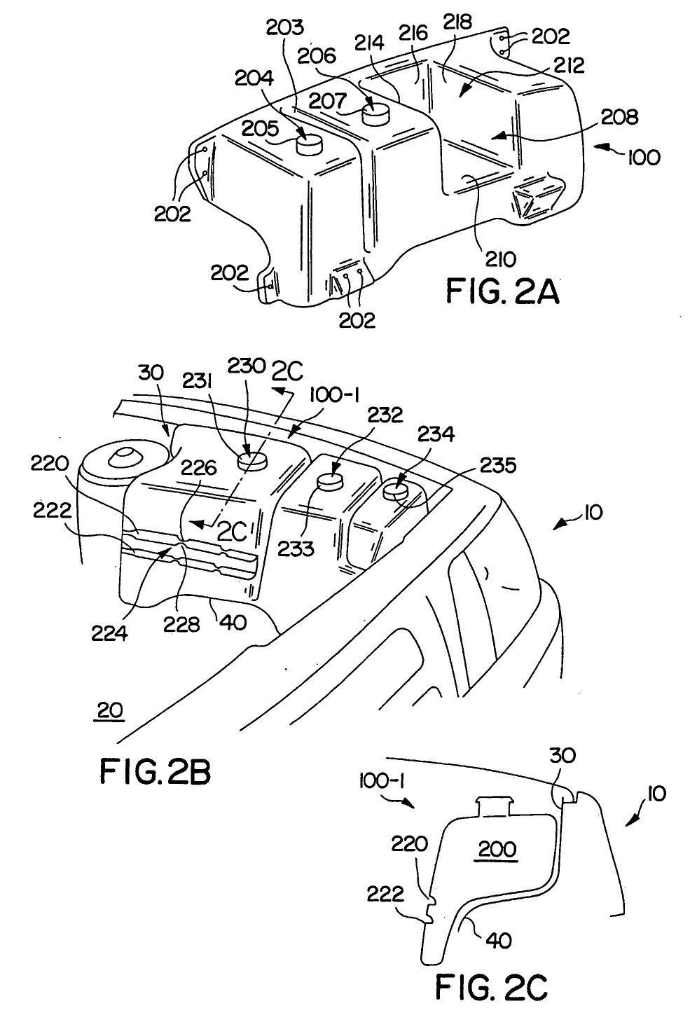

FIG. 2A is a perspective view of a hollow structure 100 according to the present invention;

FIG. 2B is a perspective view of a hollow structure 100-1 according to the present invention installed in a motor vehicle;

FIG. 2C is a cross-sectional view of the hollow structure 100-1 of FIG. 2B taken along line 2C of FIG. 2B;

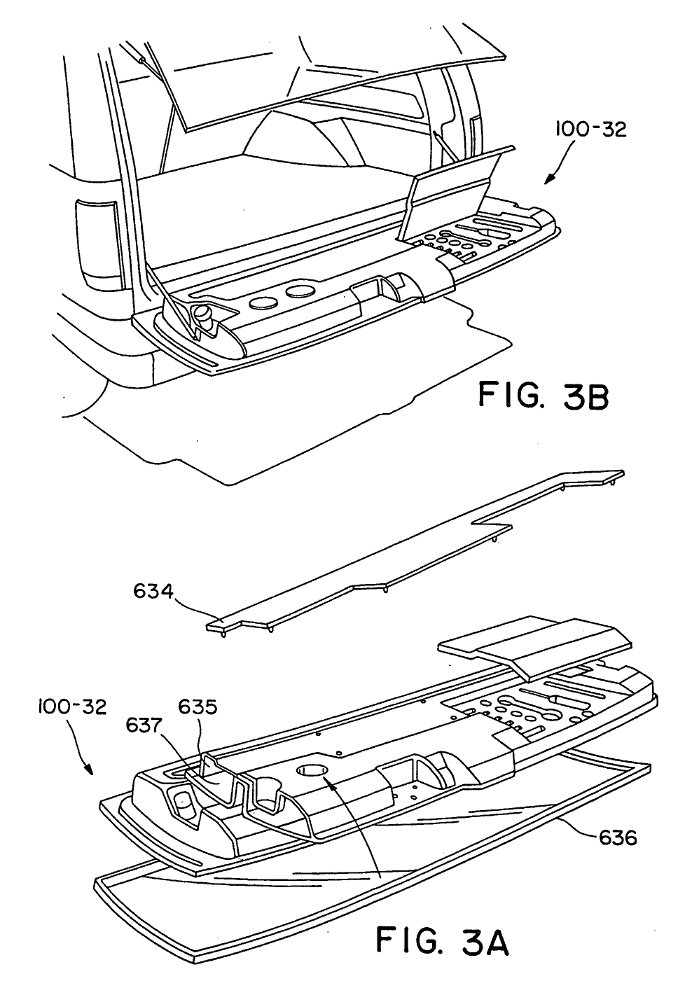

FIG. 3A is a perspective view of a hollow structure 100-32 according to the present invention with cavity 637 shown in partial cut away view of the wall structure;

FIG. 3B is a perspective view of the hollow structure 100-32 of FIG. 3A installed in a motor vehicle;

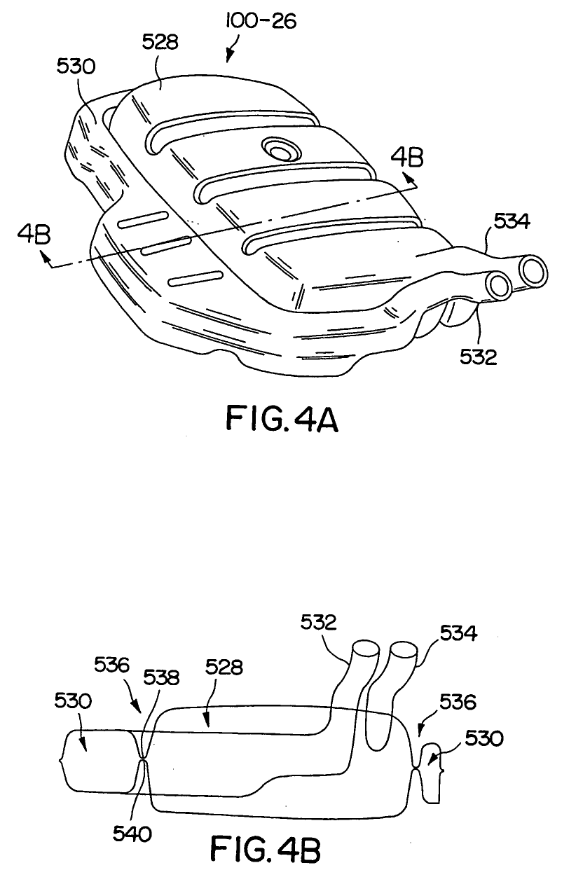

FIG. 4A is a perspective view of a hollow structure 100-26 according to the present invention;

FIG. 4B is a cross-sectional view of the hollow structure 100-26 of FIG. 4A taken along line 4B of FIG. 4A;

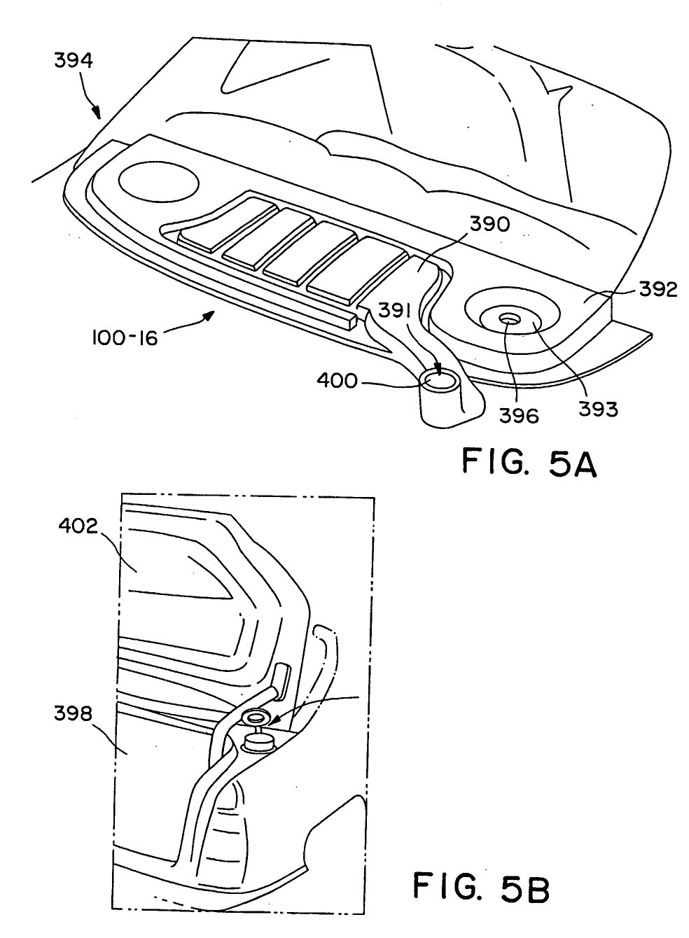

FIG. 5A is a perspective view of a hollow structure 100-16 according to the present invention;

FIG. 5B is a perspective view of the hollow structure 100-16 of FIG. 5A installed in a motor vehicle;

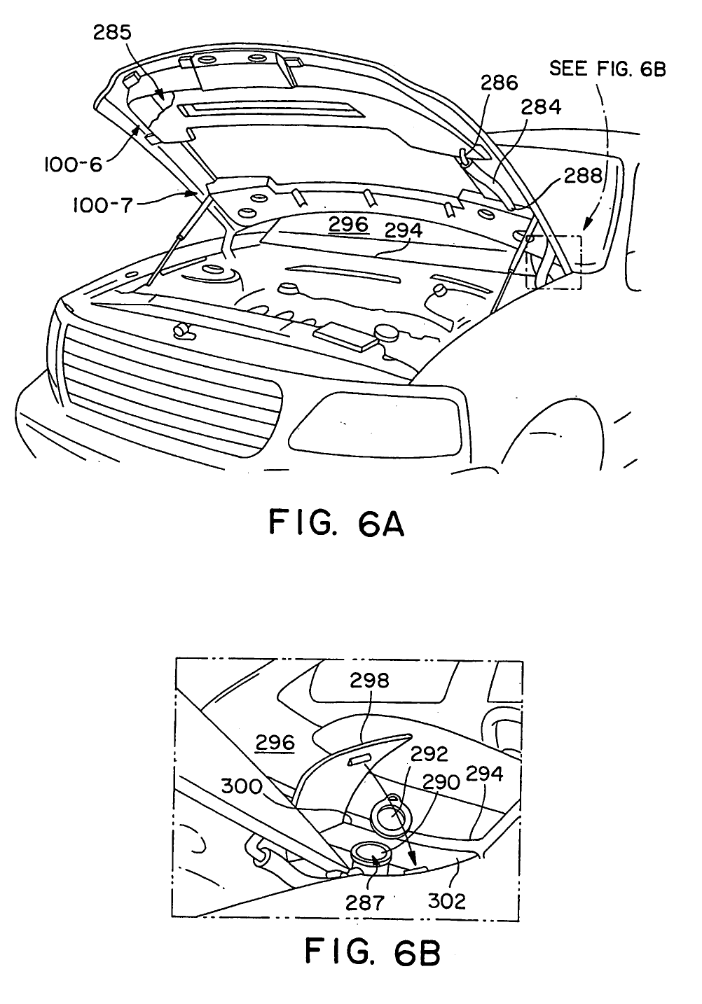

FIG. 6A is a perspective view of hollow structures 100-6 and 100-7 according to the present invention installed in a motor vehicle with cavity 285 of hollow structure 100-6 shown in partial cut away view of the wall structure;

FIG. 6B is an enlarged partial view of FIG. 6A;

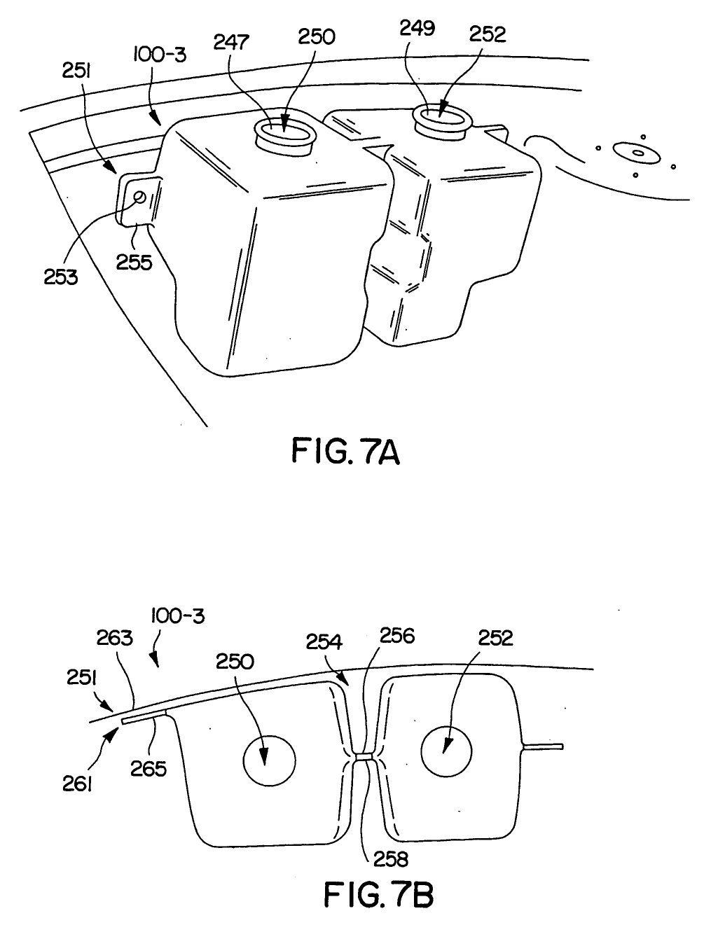

FIG. 7A is a perspective view of a hollow structure 100-3 according to the present invention;

FIG. 7B is a top view of the hollow structure 100-3 of FIG. 7A;

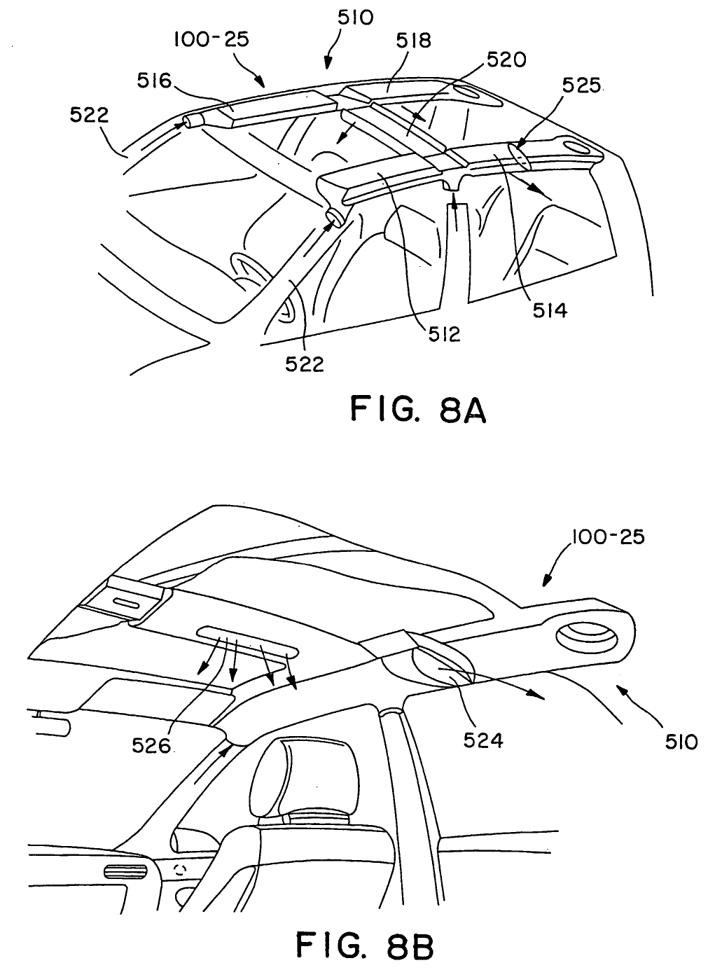

FIG. 8A is a top perspective view of a hollow structure 100-25 according to the present invention with cavity 525 shown in partial cut away view of the wall structure;

FIG. 8B is a lower perspective view of the hollow structure 100-25 of FIG. 8A installed in a motor vehicle;

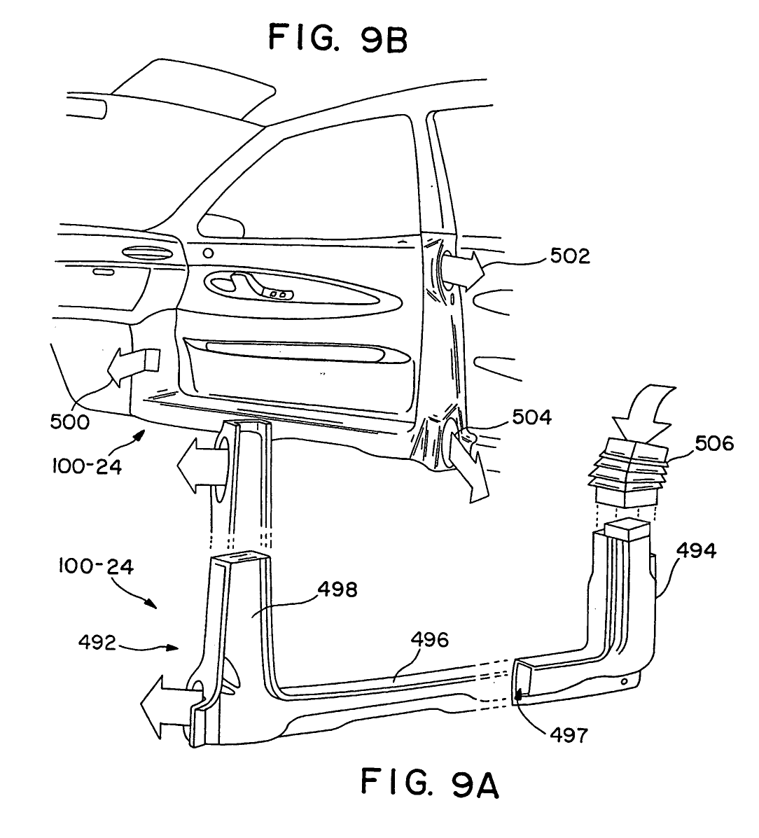

FIG. 9A is a rear perspective view of a hollow structure 100-24 according to the present invention with cavity 497 shown in partial cut away view of the wall structure;

FIG. 9B is a front perspective view of the hollow structure 100-24 of FIG. 9A installed in a motor vehicle;

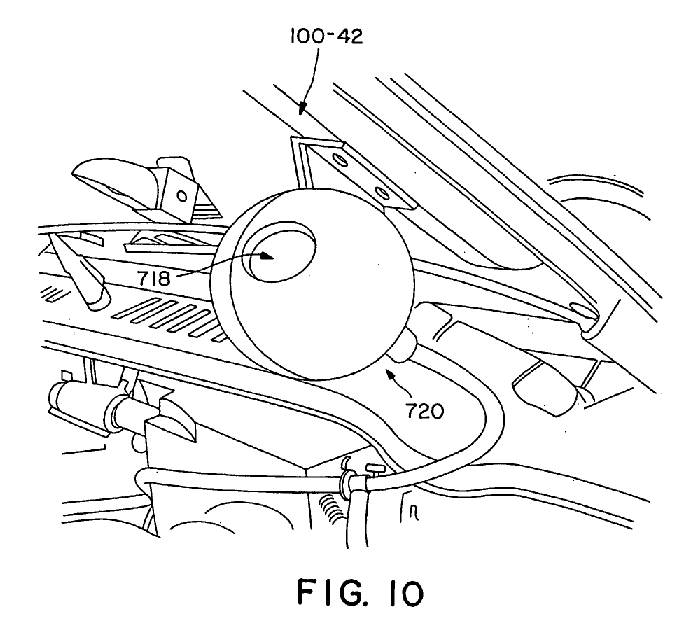

FIG. 10 is a perspective view of a hollow structure 100-42 according to the present invention with cavity 718 shown in partial cut away view of the wall structure;

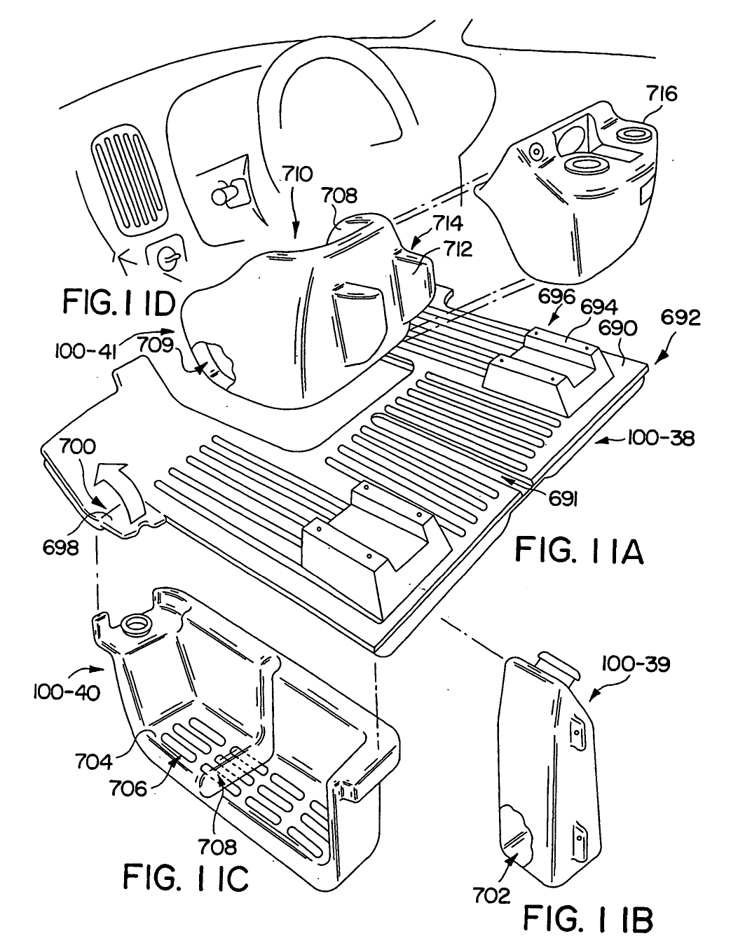

FIG. 11A is a perspective view of a hollow structure 100-38 according to the present invention oriented in a motor vehicle;

FIG. 11B is a perspective view of a hollow structure 100-39 according to the present invention with cavity 702 shown in partial cut away view of the wall structure;

FIG. 11C is a perspective view of a hollow structure 100-40 according to the present invention;

FIG. 11D is a perspective view of a hollow structure 100-41 according to the present invention with cavity 709 shown in partial cut away view of the wall structure;

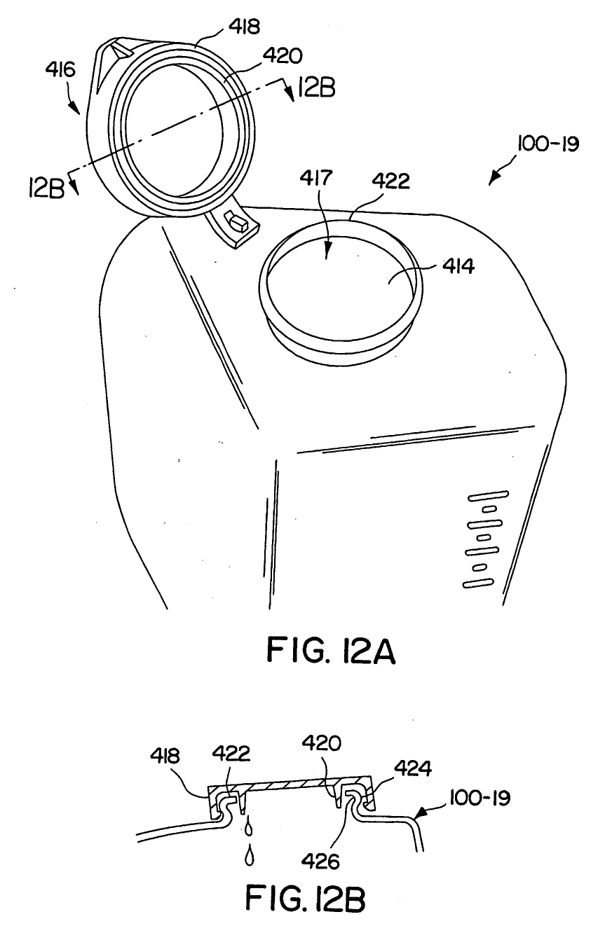

FIG. 12A is a perspective view of a hollow structure 100-19 and cover according to the present invention;

FIG. 12B is a cross-sectional view of the of the hollow structure 100-19 and cover of FIG. 12A as assembled taken along line 12B of FIG. 12A;

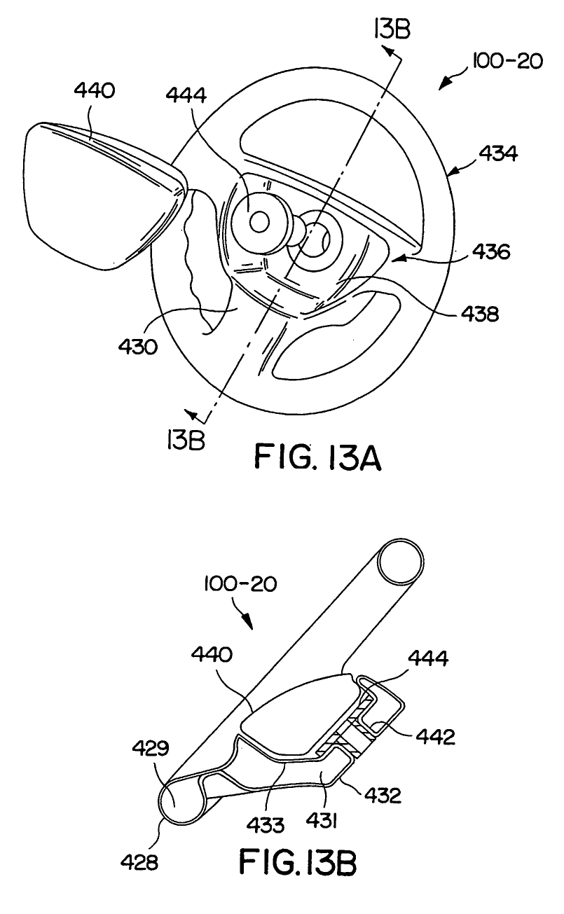

FIG. 13A is a perspective view of a hollow structure 100-20 according to the present invention;

FIG. 13B is a cross-sectional view of the hollow structure 100-20 of FIG. 13A as assembled taken along line 13B of FIG. 13A;

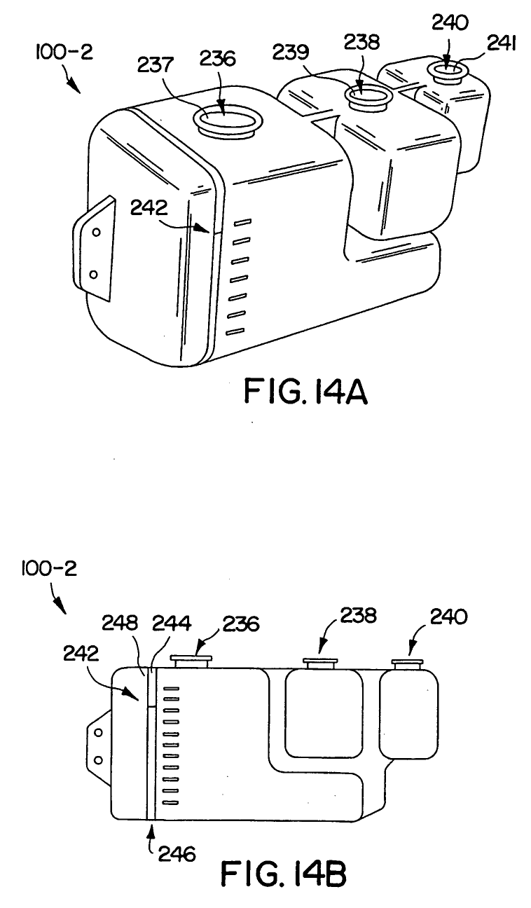

FIG. 14A is a perspective view of a hollow structure 100-2 according to the present invention;

FIG. 14B is a side view of the hollow structure 100-2 of FIG. 14A;

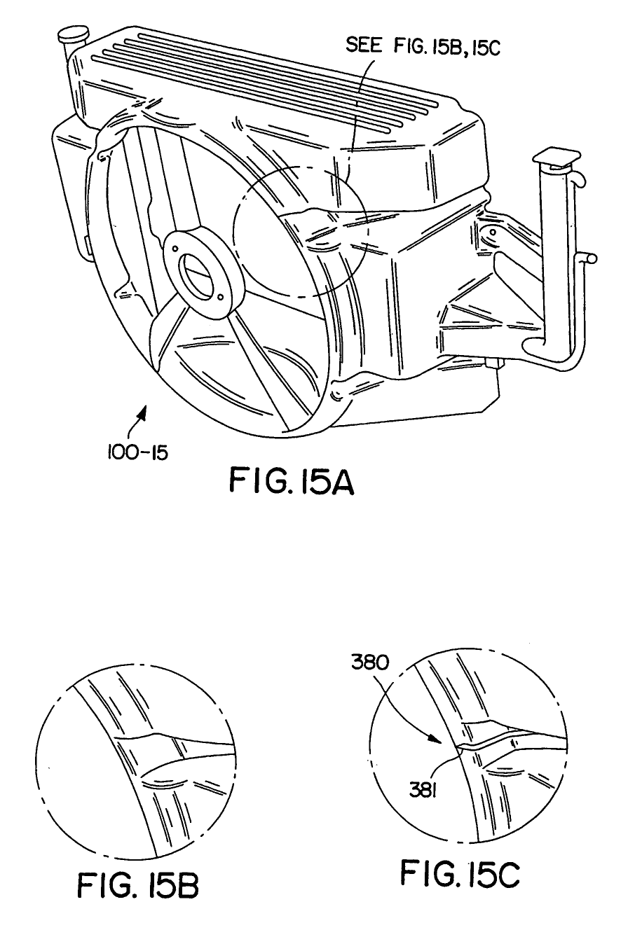

FIG. 15A is a perspective view of a hollow structure 100-15;

FIG. 15B is an enlarged partial view of FIG. 15A;

FIG. 15C is an enlarged partial view of the hollow structure 100-15 according to the present invention;

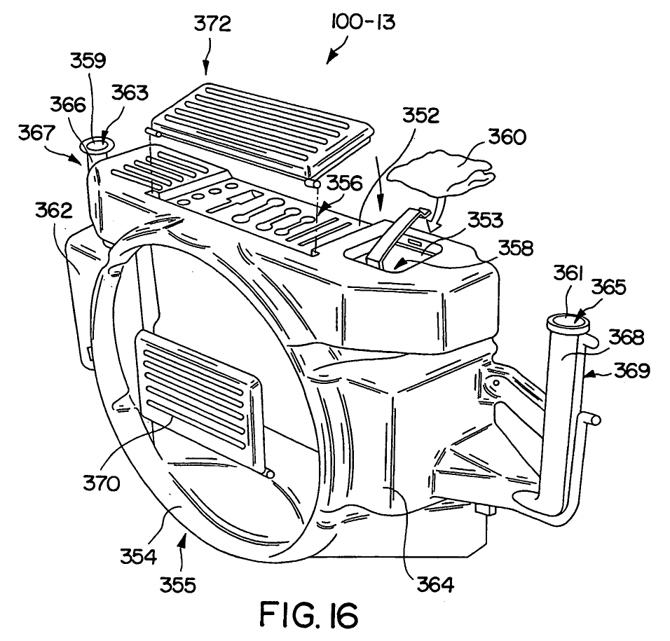

FIG. 16 is a perspective view of a hollow structure 100-13 according to the present invention;

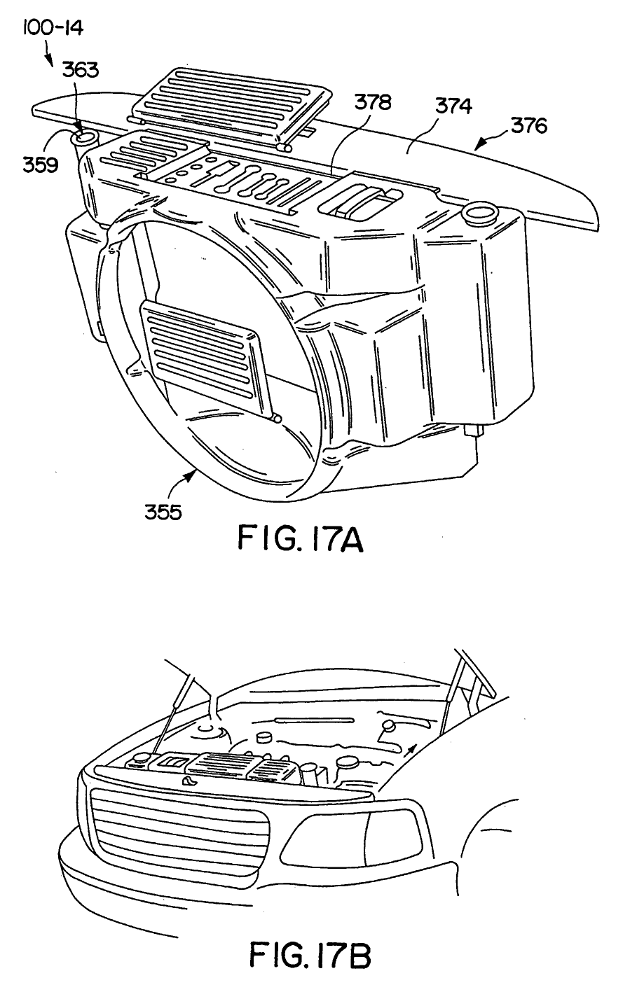

FIG. 17A is a perspective view of a hollow structure 100-14 according to the present invention;

FIG. 17B is a perspective view of the hollow structure 100-14 of FIG. 17A installed in a motor vehicle;

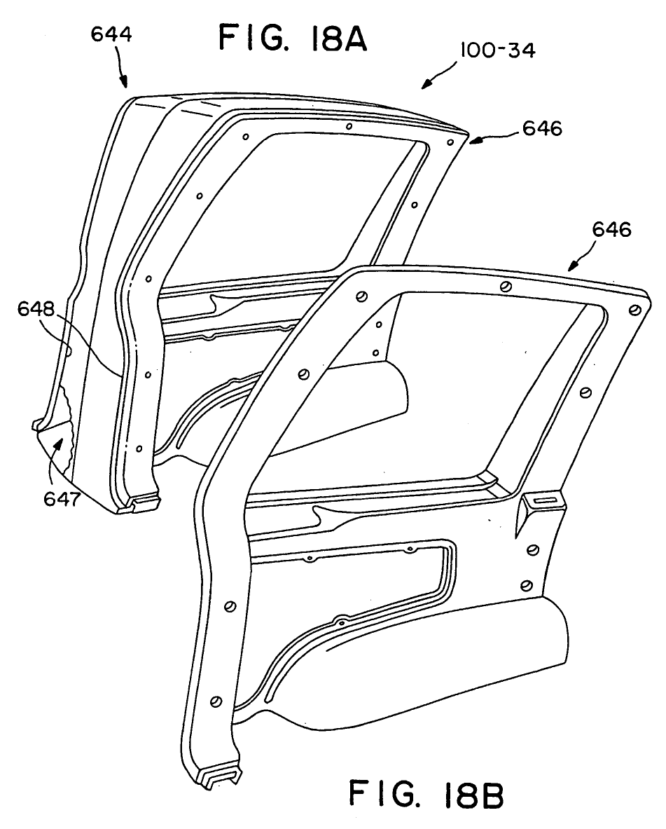

FIG. 18A is a perspective view of a hollow structure 100-34 according to the present invention with cavity 647 shown in partial cut away view of the wall structure;

FIG. 18B is a perspective view of a section of the hollow structure 100-34 of FIG. 18A after trimming;

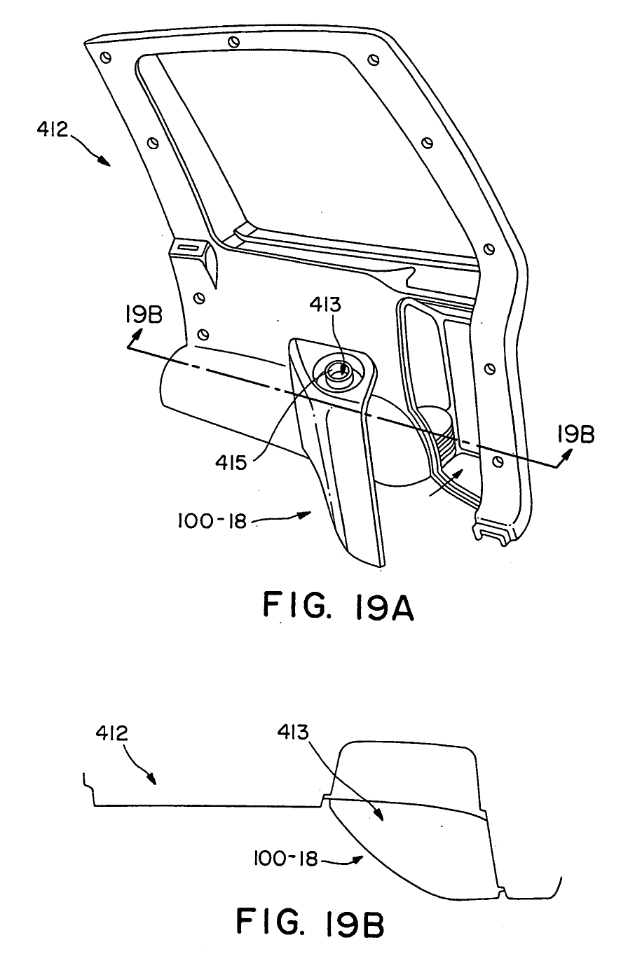

FIG. 19A is a perspective view of a hollow structure 100-18 and an interior trim component according to the present invention;

FIG. 19B is a cross-sectional view of the hollow structure 100-18 and interior trim component of FIG. 19A as assembled taken along line 19B of FIG. 19A;

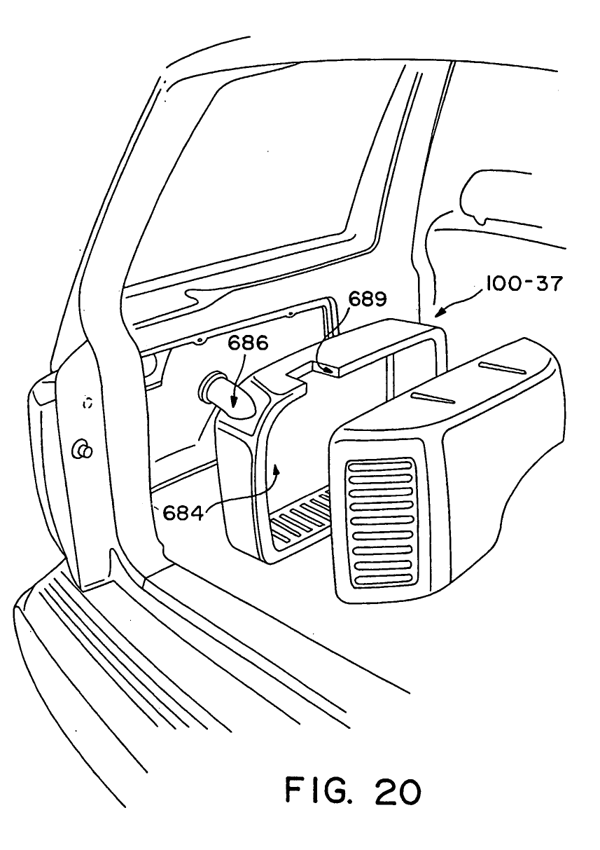

FIG. 20 is a perspective view of a hollow structure 100-37 according to the present invention with cavity 689 shown in partial cut away view of the wall structure;

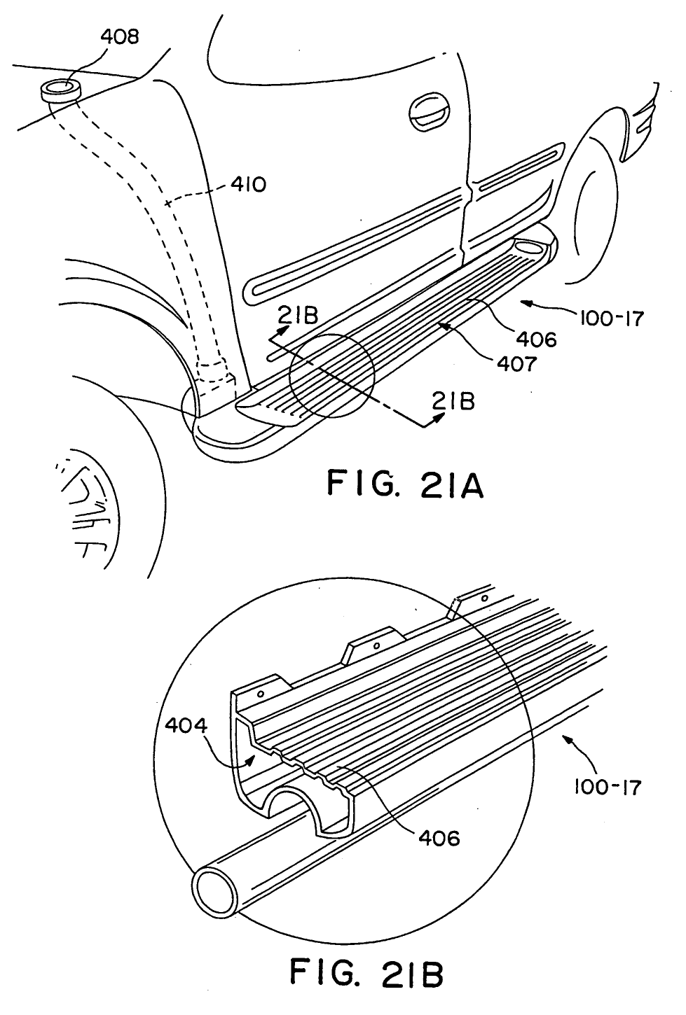

FIG. 21A is a perspective view of a hollow structure 100-17 according to the present invention installed in a motor vehicle;

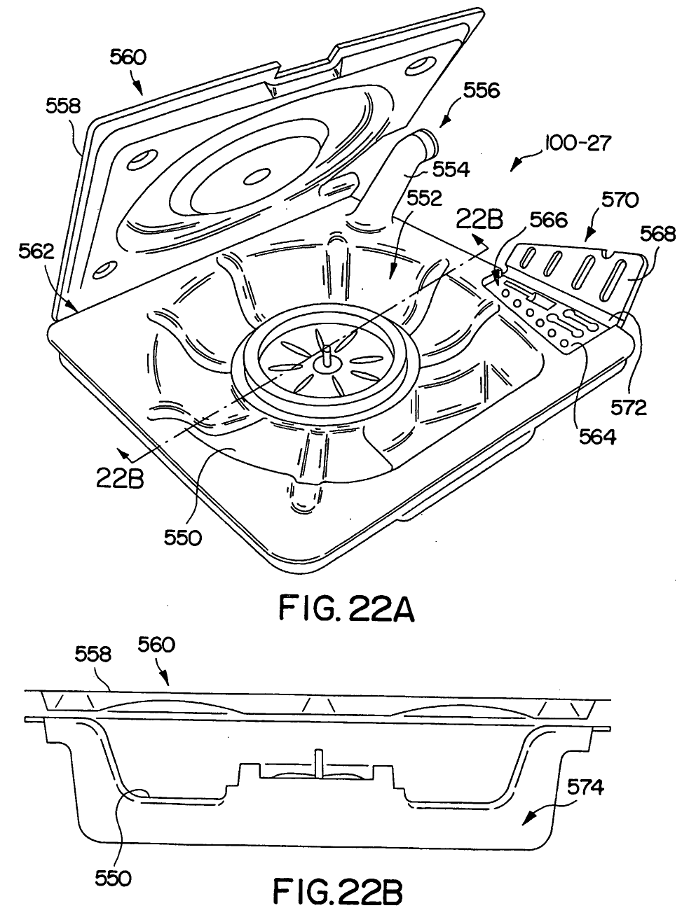

FIG. 21B is an enlargened cross-sectional view of the hollow structure 100-17 of FIG. 21A taken along line 21B of FIG. 21A; FIG. 22A is a perspective view of a hollow structure 100-27 according to the present invention;

FIG. 22B is a cross-sectional view of the hollow structure 100-27 of FIG. 22A in a closed position taken along line 22B of FIG. 22A;

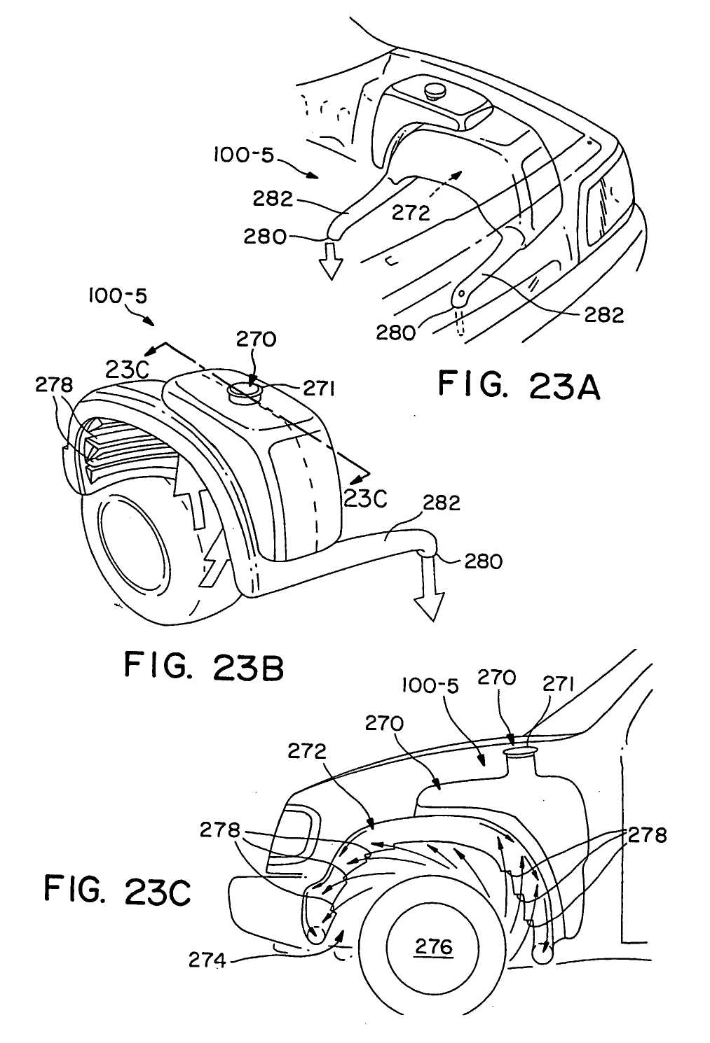

FIG. 23A is a front perspective view of a hollow structure 100-5 according to the present invention installed in a motor vehicle;

FIG. 23B is a rear perspective view of the hollow structure 100-5;

FIG. 23C is a cross-sectional view of the hollow structure 100-5 of FIG. 23B taken along line 23C of FIG. 23B;

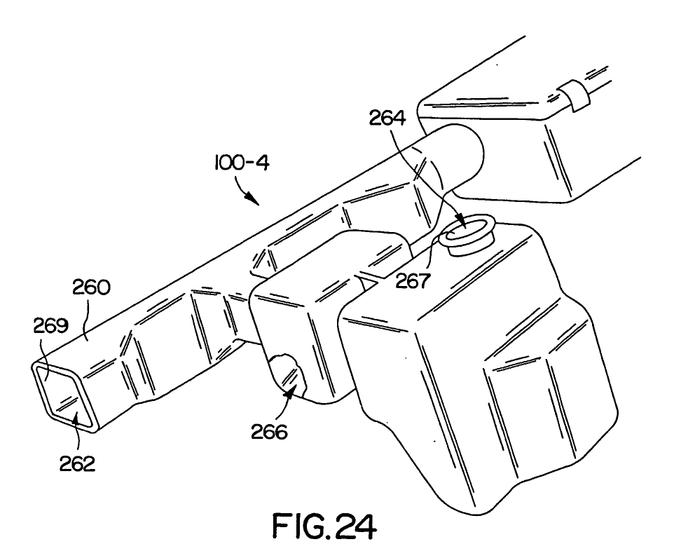

FIG. 24 is a perspective view of a hollow structure 100-4 according to the present invention;

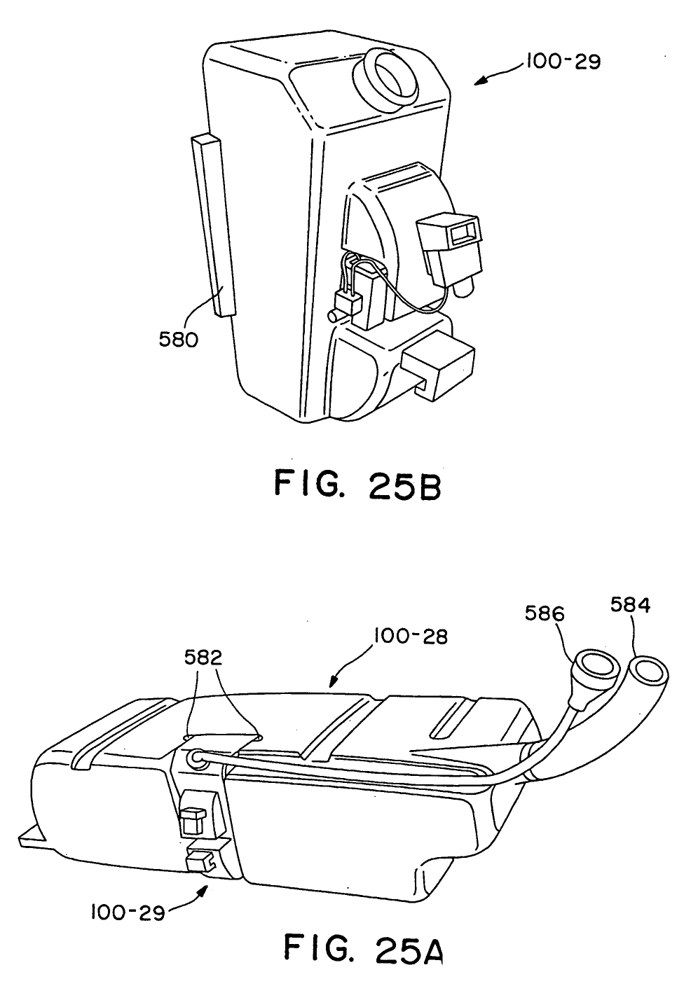

FIG. 25A is a perspective view of hollow structures 100-28 and 100-29 assembled according to the present invention;

FIG. 25B is a perspective view of hollow structure 100-29 of FIG. 25A;

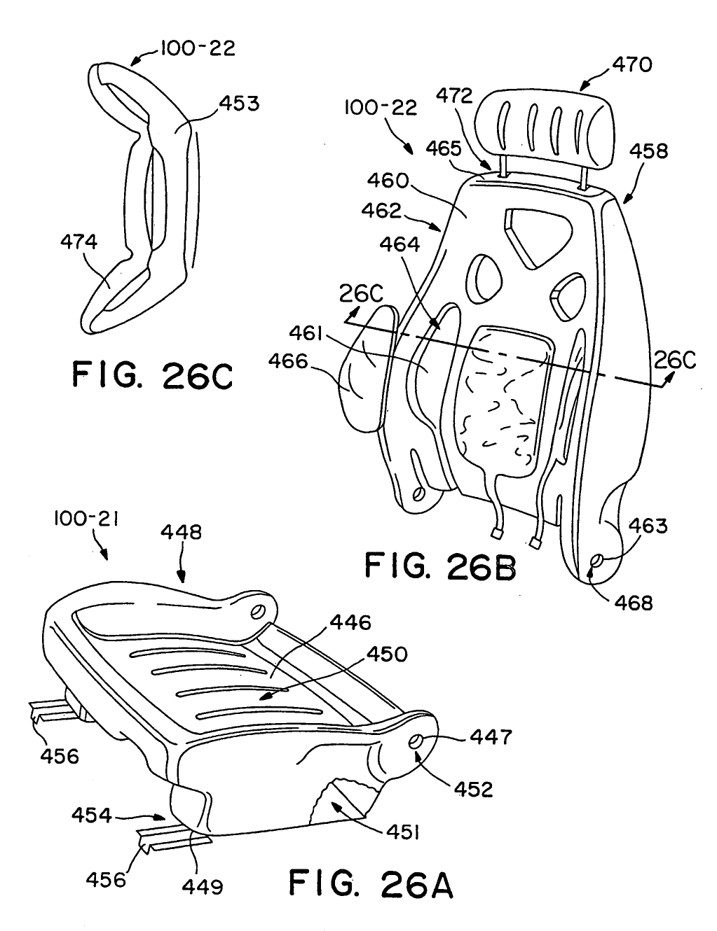

FIG. 26A is a perspective view of a hollow structure 100-21 according to the present invention with cavity 451 shown in partial cut away view of the wall structure;

FIG. 26B is a perspective view of a hollow structure 100-22 according to the present invention;

FIG. 26C is a cross-sectional view of the hollow structure 100-22 of FIG. 26B taken along lone 26C of FIG. 26B;

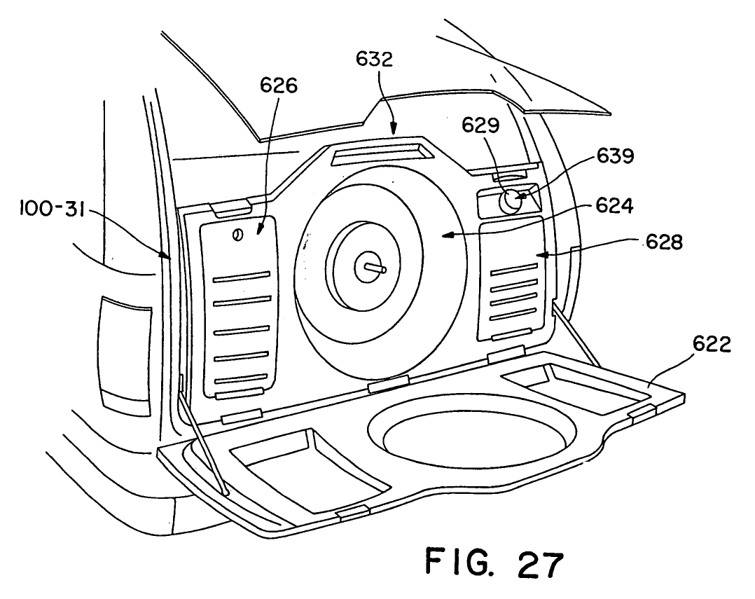

FIG. 27 is a perspective view of a hollow structure 100-31 according to the present invention installed in a motor vehicle;

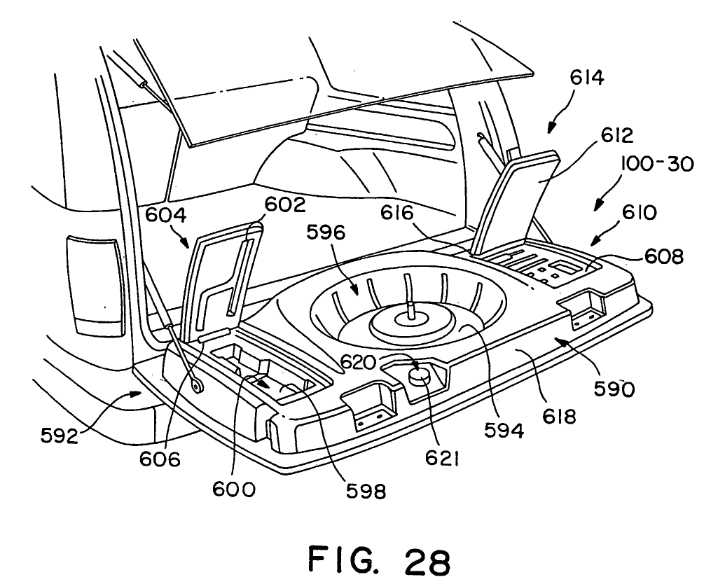

FIG. 28 is a perspective view of a hollow structure 100-30 according to the present invention installed in a motor vehicle;

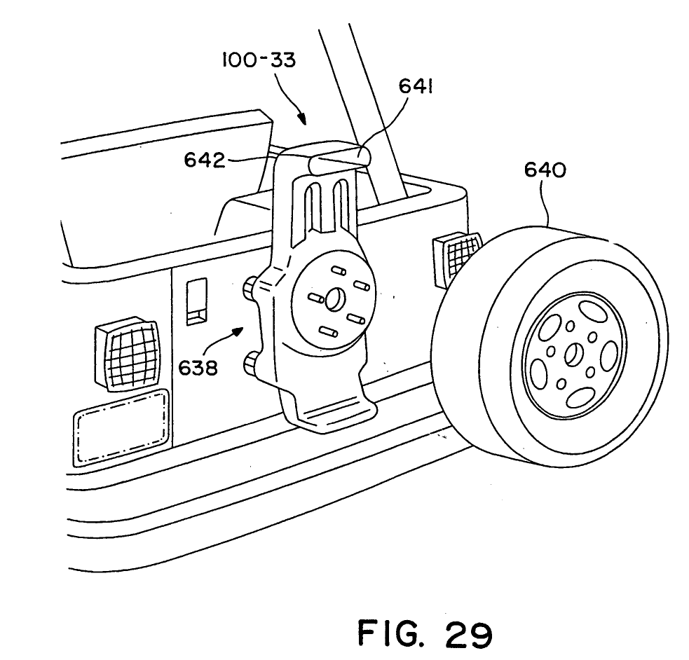

FIG. 29 is a perspective view of a hollow structure 100-33 according to the present invention with cavity 641 shown in partial cut away view of the wall structure;

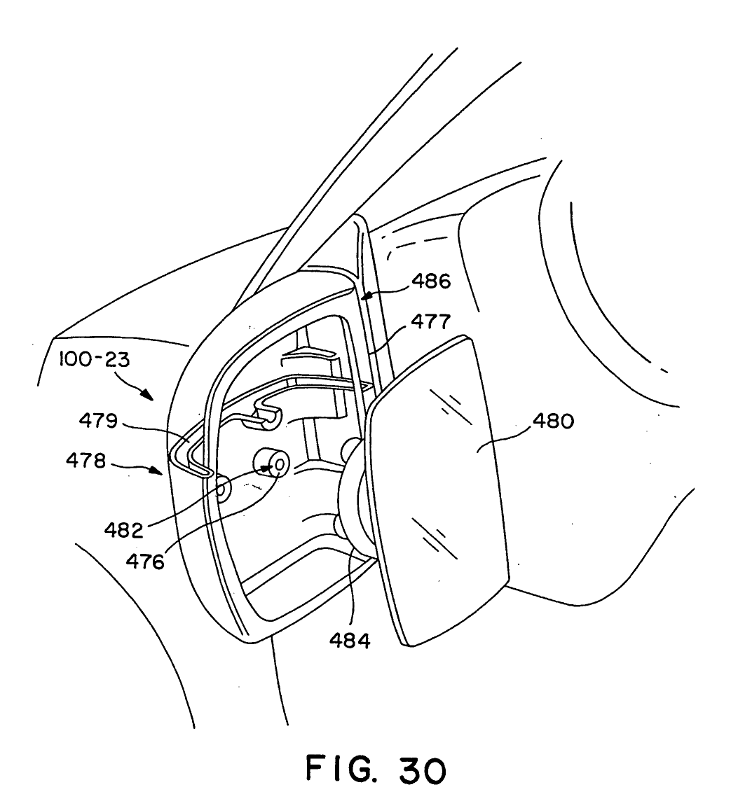

FIG. 30 is a perspective view of a hollow structure 100-23 according to the present invention with cavity 479 shown in partial cut away view of the wall structure;

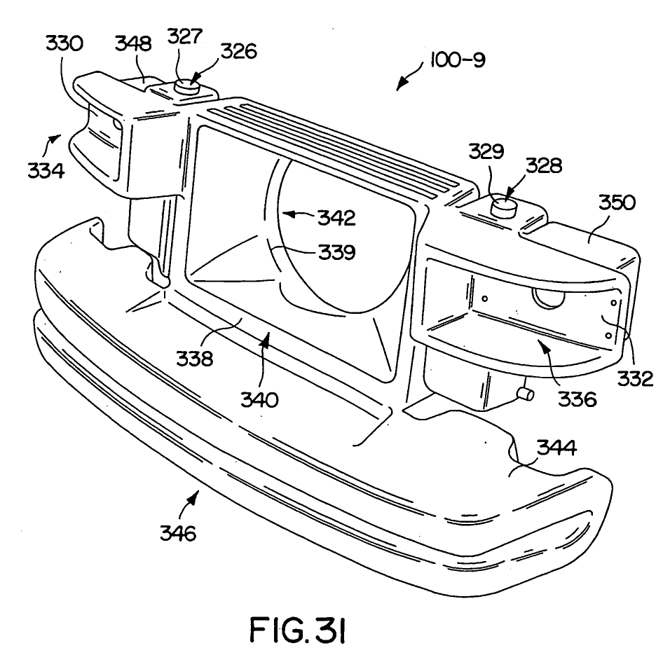

FIG. 31 is a perspective view of a hollow structure 100-9 according to the present invention;

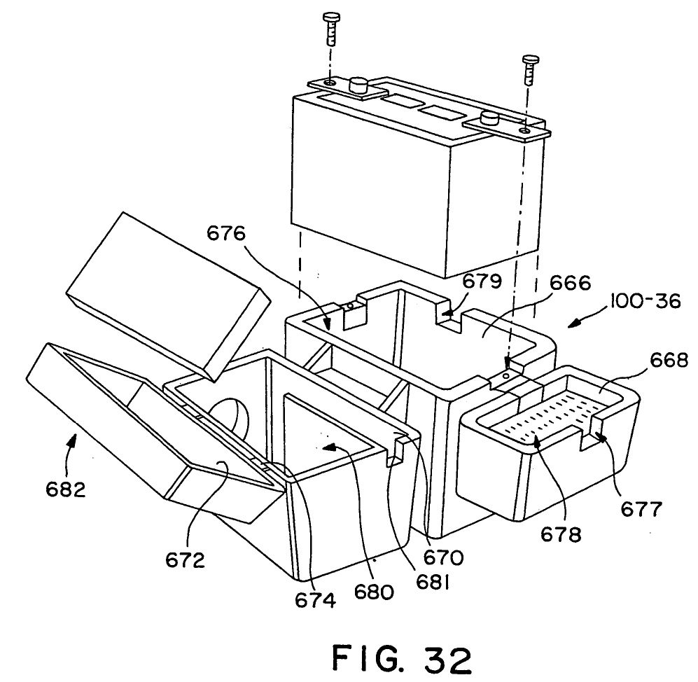

FIG. 32 is a perspective view of a hollow structure 100-36 according to the present invention with cavities 677, 679 and 681 shown in partial cut away view of the wall structure;

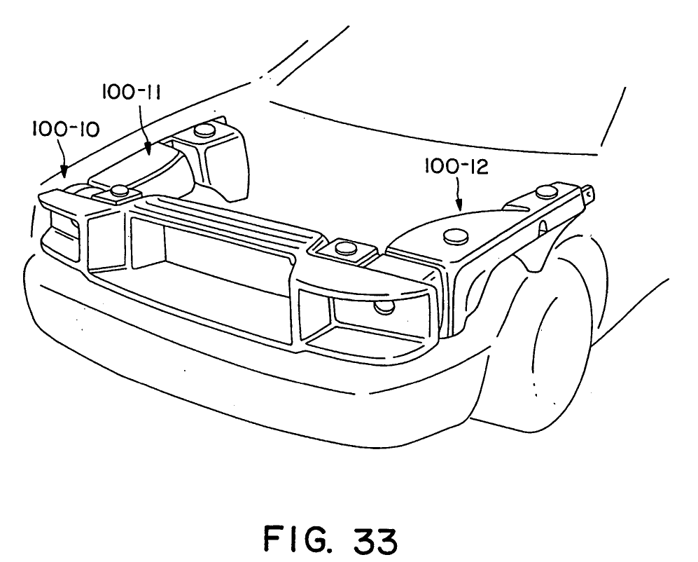

FIG. 33 is a perspective view of hollow structures 100-10, 100-11 and 100-12 assembled according to the present invention and installed in a motor vehicle;

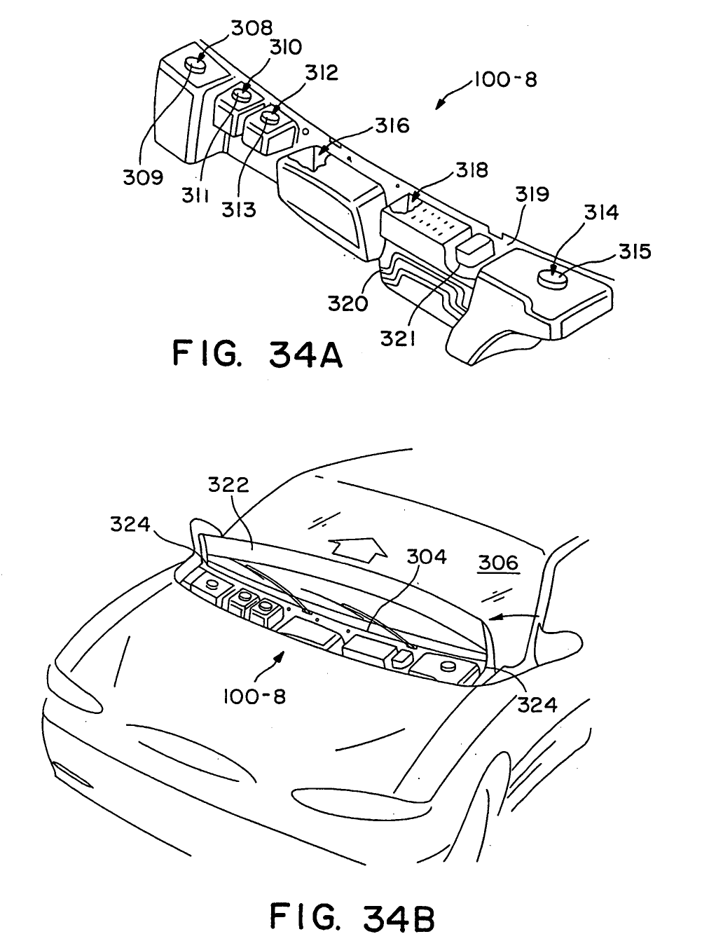

FIG. 34A is a perspective view of a hollow structure 100-8 according to the present invention with cavities 316 and 318 shown in partial cut away view of the wall structure;

FIG. 34B is a perspective view of the hollow structure 100-8 installed in a motor vehicle.

A hollow structure according to the present invention is shown in FIG. 2A at 100. Similar to hollow structure 100-1 shown in FIG. 2B, hollow structure 100 may be located in the engine compartment 20 of a motor vehicle 10. More specifically, also similar to hollow structure 100-1, hollow structure 100 may be located along the fender inner panel 30 above the wheel well liner 40 as shown in FIG. 2B.

At least a portion of the wall structure of hollow structure 100 has an interior contour defining at least one interior cavity (i.e. space) formed within the confines of the wall structure. An exemplary interior cavity typical of the hollow structures disclosed within is shown at 200 in FIG. 2C. As shown in FIG. 2A, hollow structure 100 comprises a first cavity 204 and a second cavity 206. First cavity 204 and second cavity 206 are separated by a pinched region 203, a discussion on which appears below. While hollow structure 100 comprises two adjacent cavities 204, 206 as shown, hollow structure 100 may comprise any number of cavities.

Cavities 204, 206 may by used to contain any number of suitable vehicle components, particularly fluids (e.g. liquids, gases). Consequently, the entrance of each cavity 204, 206 may be defined by and accessed through at least one aperture 205, 207, respectively, for inserting or otherwise receiving contents into the cavities 204, 206 and/or removing or otherwise withdrawing contents from the cavities 204, 206.

Examples of fluids which may be contained in cavities 204, 206 include, but are not limited to, water, washer fluids, antifreeze/coolant, engine oil, transmission fluid, brake fluid, and power steering fluid. In an exemplary embodiment, cavities 204, 206 are used to contain antifreeze/coolant for a vehicle antifreeze/coolant overflow/recovery reservoir and washer fluid for a washer reservoir, respectively.

In the case where a cavity comprises a fluid reservoir, the cavity may be configured such that fluids contained in the cavity cannot enter into another cavity of the hollow structure, if another cavity is present. Such may be necessary, for example, to prevent fluid contamination or loss. In such an instance, it may be necessary that the cavity containing the fluid be completely separated from other cavities of the hollow structure.

In another feature of the invention, hollow structure 100 may comprise a battery holder. For example, as shown in FIG. 2A, the exterior contour of a wall section of hollow structure 100 comprises a battery holder 208 which may be used to hold one or more batteries (not shown). Among other things, the battery may be used to provide power for starting an internal combustion engine, or providing power to an electric motor for an electrically powered vehicle.

As shown in FIG. 2A, the exterior contour of a wall section of cavity 206 of hollow structure 100 comprises a battery holder 208. More particularly, the exterior contour of a wall section of cavity 206 comprises a battery holder platform 210, upon which a battery may be located, and may comprise one or more battery holder sidewalls which comprise a battery holder receptacle 212 which at least partially surrounds the battery. As shown FIG. 2A, battery holder 208 comprises sidewalls 214, 216, and 218 which comprise a three-sided rectangular receptacle 212 and surround a corresponding rectangular battery on three sides. While not illustrated, in other embodiments the battery may be completely surrounded on all four sides by a four sided receptacle thus providing a box-like structure. With regards to depth of the receptacle 212, preferably the depth is equal to or greater than the height of the battery such that the battery may be covered by a cover (not shown) to conceal the battery in certain applications.

As shown in FIG. 2A, at least a portion of the wall structure defining cavity 206 and at least a portion of the wall structure comprising the battery holder 208 are comprised of at least partially the same wall structure. Furthermore, as shown in FIG. 2A, at least a portion of cavity 206 and at least a portion of the battery holder 208 are disposed on opposite sides of a same portion of the wall structure.

In another feature of the invention, hollow structure 100 may comprise a cooling or heating device for a battery. For example, cavity 206 of hollow structure 100 may comprise a cooling device for a battery where the cavity 206 is filled with fluid (e.g. washer fluid) cooled to a temperature below the ambient temperature of the battery. Conversely, cavity 206 of hollow structure 100 may comprise a heating device for a battery where the cavity 206 is filled with fluid (e.g. antifreeze or water from the radiator) heated to a temperature above the ambient temperature of the battery.

Cooling or heating of the battery may be accomplished via conduction if the outer surfaces of the battery housing are in direct contact with the outer surfaces of the wall sections 210, 214, 216 or 218 of cavity 206 of hollow structure 100, or convection if the outer surfaces of the battery housing and the hollow structure 100 are separated by an air gap.

In another feature of the invention, hollow structure 100 may be connected to a structure within the engine compartment 20 of vehicle 10 (e.g. the inner fender panel 30) via at least one attachment location 202. For example, as shown in FIG. 2A, attachment location 202 may comprise a plurality of apertures disposed on flanges through which a threaded fastener may be inserted, or another attachment device may be applied, and attached to the inner fender panel 30 to engage hollow structure 100.

In another feature of the invention, hollow structure 100 may comprise at least one cable guide. In various instances, cable guides may be used to hold any type of cable, wire, hose, or similar tube-like elongated structure. For example, as shown in FIG. 2B, hollow structure 100-1 comprises cavities 230, 232 and 234, the entrance of which is provided by apertures 231, 233 and 235, respectively. Furthermore, as shown, the exterior contour of a wall section of cavity 230 comprises two cable guides 220, 222, preferably for positive and negative battery leads (not shown). As shown in FIGS. 2B and 2C, cable guides 220, 222 preferably comprise an elongated semi-circular (i.e. less than a full circle) channel formed as a recess in a wall section of cavity 230 which may hold or contain the battery leads as to restrict their free movement

In addition, the cable guides 220, 222 may comprise a crimping mechanism 224 comprising two opposing localized tabs 226, 228 which narrow localized sections of the channel as to pinch a battery lead when placed therein to hold the battery lead from free movement.

As shown in FIGS. 2B and 2C, at least a portion of the wall structure defining cavity 230 and at least a portion of the wall structure comprising the cable guides 220, 222 are comprised of at least partially the same wall structure. Furthermore, as shown in FIGS. 2B and 2C, at least a portion of cavity 230 and at least a portion of the cable guides 220, 222 are disposed on opposite sides of a same portion of the wall structure.

In another feature of the invention, hollow structure 100 may comprise at least one fluid level indicator. For example, as shown in FIG. 14A, hollow structure 100-2 comprises cavities 236, 238 and 240, the entrance of which is provided by apertures 237, 239 and 241, respectively. Furthermore, as shown, a wall section of cavity 236 comprises a fluid level indicator 242 formed therein. While not shown, in other instances each cavity of the hollow structure may have its own fluid level indicator.

Fluid level indicator 242 preferably comprises a strip section 246 formed in a wall section 244 of cavity 236 with greater translucency than that of the adjoining wall section 248 of cavity 236. More preferably, fluid level indicator 242 comprises a wall section 244 of plastic material with greater translucency than that of the plastic material comprising the adjoining wall section 248. In such an instance, strip section 246 of wall section 244 preferably comprises an unpigmented plastic material while the adjoining wall section 248 comprises a pigmented plastic. Furthermore, adjoining wall section 248 preferably comprises a recycled (i.e. non-virgin) plastic and is pigmented black.

In another feature of the invention, hollow structure 100 may comprise at least one pinched region 203 which defines cavities 204, 206 on either side thereof. Alternatively, a pinched region may merely define a narrower cross-section in a single cavity. For example, a pinched region in a single cavity may be used to at least partially define multiple wells containing fluids therein where separation or containment of the fluids contained in the wells is not necessary. Such may be possible where the wells contain fluids which may be mixable or contain the same fluid (e.g. an adjacent well may function as a spill-over well for a first well which becomes completely filled and incapable of retaining additional fluid), in which case the wells are only partially separated from each other by the pinched region.

A pinched region may comprise a first wall section and a second wall section (for example, with blow molding) in which at least one of the two wall sections extends towards the other wall section as to narrow the cavity between the two wall sections as compared to adjoining wall sections, respectively. Generally, the first wall section and second wall section are on opposite wall sections of the hollow structure. For example, as shown in FIGS. 7A and 7B, hollow structure 100-3 comprises a pinched region 254 which, in this case, defines cavities 250, 252 on either side thereof, the entrance of which is provided by apertures 247 and 249, respectively. As shown in FIG. 7B, pinched region 254 comprises a first wall section 256 and a second wall section 258. As shown, both first wall section 256 and a second wall section 258 extend towards each other (inwards towards the interior confines of the hollow structure 100-3). Furthermore, first wall section 256 and second wall section 258 extend towards each other and make contact as to eliminate the presence of a cavity between the two wall sections 256, 258 and define cavities 250, 252 on either side thereof.

Preferably, the first wall section 256 and second wall section 258 are bonded during the formation of hollow structure 100-3. This particular method of thermal bonding, in which the bonding substance comprises the material of the wall sections 256, 258 themselves, may be more particularly referred to as autogenic bonding and a temperature at which the wall sections 256, 258 are capable of autogenic bonding may be referred to as an autogenic bonding temperature.

In another feature of the invention, hollow structure 100 may comprise at least one pinched region which comprises an attachment location. For example, as shown in FIGS. 7A and 7B, hollow structure 100-3 comprises an attachment location 251 which comprises an aperture 253 disposed on a flange 255 through which a threaded fastener, or other attachment device, may be inserted and attached to the inner fender panel to engage hollow structure 100-3. As shown, flange 255 comprises a pinched region 261 comprising a first wall section 263 and a second wall section 265 which are thermally bonded as described above.

Pinched regions similar to those described above are shown in hollow structures throughout this specification. Whether a pinched region is used to comprise a narrower cross-section in a single cavity or comprise multiple cavities on either side thereof, is generally determined by whether a cavity comprises a fluid reservoir and, if so, whether the cavity must be configured such that fluids contained in the cavity cannot enter another cavity as discussed above.

In another feature of the invention, hollow structure 100 may contain vehicle components other than vehicle fluids. For example, as shown in FIG. 24, hollow structure 100-4 comprises a cavity 262, the entrance of which is provided by aperture 269, for holding another type of vehicle component (i.e. non-fluid), such as a filter. As shown in FIG. 24, hollow structure 100-4 comprises a cavity 262 for containing an air filter. However, in other instances, the filter may also comprise, for example, a fuel filter, a HVAC (heating, ventilation or air conditioning) filter or an oil filter. Furthermore, hollow structure 100-4 may comprise a cavity 264, the entrance of which is provided by aperture 267, for holding vehicle fluid, such as washer fluid.

In another feature of the invention, hollow structure 100 may comprise one or more ducts for guiding air or vehicle components (e.g. fluid, wire, cable, hose) contained therein. For example, as shown in FIG. 24, hollow structure 100-4 comprises a duct 260 for directing the flow of air from an air source to the cavity 262 containing the air filter.

In another feature of the invention, hollow structure 100 may comprise an acoustic resonator. For example, as shown in FIG. 24, hollow structure 100-4 comprises cavity 266, shown in partial cut-away view of the wall structure, which comprises an acoustic resonator for attenuating vibration and any associated sound, particularly noise. Unlike some other cavities disclosed within, cavity 266 may be filled with a gaseous fluid, such as air, and may not have any aperture for receiving contents therein or withdrawing contents therefrom.

Exemplary features of hollow structures 100, 100-1, 100-2, 100-3 and 100-4 include multiple cavities built into a single piece structure, easy identification of fill and level points with the fluid level indicator, and packaging around the wheel well. Furthermore, additional benefits of the single piece structure include component consolidation, simplified assembly complexity, lower vehicle mass, lower fastener count, faster assembly in the plant, and the ability to be manufactured with recycled material.

In another feature of the invention, hollow structure 100 may comprise a wheel well liner. For example, as shown in FIG. 23C, hollow structure 100-5 comprises a cavity 272. Furthermore, as shown, the exterior contour of a wall section of cavity 272 comprises a wheel well liner 274. Furthermore, hollow structure 100-5 may comprise a cavity 270, the entrance of which is provided by aperture 271, for containing vehicle fluid, such as washer fluid, for a reservoir.

As shown in FIG. 23C, at least a portion of the wall structure defining cavity 272 and at least a portion of the wall structure comprising wheel well liner 274 are comprised of at least partially the same wall structure. Furthermore, as shown in FIG. 23C, at least a portion of cavity 272 and at least a portion of wheel well liner 274 are disposed on opposite sides of a same portion of the wall structure.

In another feature of the invention, cavity 272 of hollow structure 100-5 may comprise an apparatus for collecting and disposing of road debris (water, sand, etc.) which is airborne (e.g. ejected from the vehicle tires 276) within the proximity of the wheel well liner 274 during vehicle travel. In order to collect the road debris, cavity 272 may be provided with at least one inlet aperture 278, or a plurality of inlet apertures 278 as shown in FIGS. 23B and 23C, which are configured to collect road debris within cavity 272. After collecting the road debris, cavity 272 may be configured to dispose of the road debris through at least one outlet aperture 280, or a plurality of outlet apertures 280 as shown in FIGS. 23A and 23B. Furthermore, as shown outlet apertures 280 may be displaced from the wheel well by a duct 282 which disposes of the road debris at a location towards the center area of the vehicle. In the instance where hollow structure 100-5 comprises both a cavity 270 configured as a reservoir for containing vehicle fluid and also comprises a wheel well liner 274, features include a modular design used to collect and dispose of road spray/debris and hold washer fluid and the simultaneous use as a wheel well liner. Consequently, benefits include deflecting road spray away from nearby vehicles.

In another feature of the invention, hollow structure 100 may comprise a hollow structure located in the engine compartment of a vehicle along the underside of the engine compartment hood. For example, as shown in FIG. 6A, hollow structures 100-6 and 100-7 are connected to the underside of the engine compartment hood of a vehicle. Hollow structure 100-6 preferably extends cross-car forward of the vehicle engine while hollow structure 100-7 preferably extends cross-car rearward of the vehicle engine. In this manner, hollow structures 100-6 and 100-7 are configured not to directly overlie the top of the engine closest the underside of the hood and thereby avoid heat from the engine capable of damaging the hollow structures, for example, where the hollow structures are made of plastic and may deform or even melt from such heat.

In another feature of the invention, hollow structures 100-6 and 100-7 may be connected to facilitate the transfer of fluids contained therein, such as washer fluid for a reservoir, between the hollow structures, or for receiving or withdrawing fluids contained therein. As shown in FIG. 6A, a hose 284 is disposed between hollow structures 100-6 and 100-7 to facilitate the transfer of fluid from hollow structure 100-7 to hollow structure 100-6 during filling of the hollow structures 100-6 and 100-7 as well as facilitating the transfer of fluid from 100-6 to 100-7 during the emptying of the hollow structures 100-6 and 100-7.

Hose 284 is preferably in fluid communication with the cavities 285, 287 of the hollow structures 100-6, 100-7, the entrance of which is provided by an aperture formed in each hollow structure 100-6, 100-7 at the end of filler tubes 286, 288 over which hose 284 may form an interference fit and/or fastened (e.g. with a hose clamp).

As shown in FIG. 6B, in order to facilitate filling of hollow structures 100-6 and 100-7, cavity 287 of hollow structure 100-7 preferably comprises an aperture 290 configured to receive fluid there-through. After filling hollow structures 100-6, 100-7, aperture 290 may be covered with a cover 292.

As shown in FIG. 6B, aperture 290 for filling hollow structures 100-6, 100-7 may be at least partially disposed in the region of the vehicle adjacent the forward lower edge 294 of the vehicle windshield 296. Typically this region includes the vehicle cowl and/or the firewall. As shown, aperture 290 is located in the vehicle cowl, in which case access to aperture 290 may be covered by an access panel 298. Access panel 298 may be movable between a closed position and an open position to facilitate access to aperture 290, as well as other components located there-beneath. As shown, access panel 298 is movable between its open and closed positions via rotation about at least one hinge 300. Also as shown, access panel 298 may comprise a section of the cowl close-out panel 302. Depending on hood design, access panel 298 may be movable between its open and closed positions when the hood is both open and closed. In this manner, hollow structures 100-6, 100-7 may be easily filled without opening the vehicle's hood.

In another application, hollow structures 100-6 and 100-7 may comprise pressurized antifreeze/coolant recovery reservoirs or so called “hot bottles” which are in fluid communication with the vehicle engine's cooling system. Conventional antifreeze/coolant recovery reservoirs receive heated fluid from a vehicle's radiator upon the opening of a pressure relief located on the radiator cap. The antifreeze/coolant recovery reservoirs themselves are not pressurized. However, unlike conventional antifreeze/coolant recovery reservoirs, hot bottles are pressurized above atmospheric pressure. Furthermore, also unlike conventional antifreeze/coolant recovery reservoirs, hot bottles are preferably configured to deaerate the antifreeze/coolant. Deaeration is preferably achieved by a reservoir configuration which is located at the highest point of the engine compartment and by a reservoir configuration which provides significant internal surface area for the fluid entering therein over which the antifreeze/coolant may deareate, both features of which are provided by hollow structure 100-6 and 100-7.

In another feature of the invention, hollow structure 100 may comprise a cross-car structure. For example, as shown in FIGS. 34A and 34B, hollow structure 100-8 comprises a cross-car structure located adjacent the lower forward edge 304 of the vehicle windshield 306. Typically this region includes the vehicle cowl and/or the firewall. As shown in FIG. 34B, hollow structure 100-8 is connected within the engine compartment of a motor vehicle adjacent the firewall.

As shown in FIG. 34A, hollow structure 100-8 may comprise cavities 308, 310, 312 and 314, the entrance of which is provided by apertures 309, 311 313 and 315, respectively, for containing vehicle fluids. Furthermore, hollow structure 100-8 may comprise cavity 316 for containing components of a vehicle's HVAC (heating, ventilation, or air-conditioning) system, particularly the blower or fan and any associated motor for such. Furthermore, hollow structure 100-8 may comprise a cavity 318 for containing components for a vehicle's electrical system, particularly fuses. Furthermore, hollow structure 100-8 may comprise at least one cable or hose guide 320 discussed and detailed above. Furthermore, the exterior contour of a wall section of hollow structure 100-8 may provide an attachment location 319 for a vehicle component 321, such as a wiper motor.

As shown in FIG. 34B, hollow structure 100-8 may be concealed by an access panel 322. Access panel 322 may be movable between a closed position and an open position to facilitate access to hollow structure 100-8. As shown, access panel 322 is movable between its open and closed positions via rotation about at least one hinge 324. Also as shown, access panel 322 may comprise the cowl close-out panel (also known as the cowl screen). Depending on hood design, the access panel 322 may be movable between its open and closed positions when the hood is both open and closed. In this manner, cavities 308, 310, 312, 314, 316, 318 of hollow structure 100-8 may be easily accessed without opening the vehicle's hood. Also in the above manner, features of hollow structure 100-8 include fluid reservoirs located in the cowl region, easy access to fill points and other serviceable components, the ability to service fluids and other vehicle components while the engine is running without exposure to the engine which increases safety, minimization of fluid freeze, and the ability to eliminate the need for an openable engine hood for servicing such fluids and other vehicle components.

In another feature of the invention, hollow structure 100 may comprise a front-end structure. In other words, a structure located forward of the vehicle's engine. For example, as shown in FIG. 31, hollow structure 100-9 comprises a front-end structure which is located in front of a vehicle's engine.

In another feature of the invention, hollow structure 100-9 may comprise cavities 326, 328, the entrance of which is provided by apertures 327 and 329, respectively, for containing vehicle fluids, such as washer fluid and/or antifreeze, for a reservoir. Furthermore, the exterior contour of a wall section 330, 332 of hollow structure 100-9 may comprise headlamp receptacles 334, 336. Furthermore, the exterior contour of a wall section 338 of hollow structure 100-9 may comprise a radiator support frame 340. Furthermore, the exterior contour of a wall section 339 of hollow structure 100-9 may comprise a fan shroud 342. Furthermore, the exterior contour of a wall section 344 of hollow structure 100-9 may comprise a bumper 346. Furthermore, the exterior contour of a wall section 348, 350 of hollow structure 100-9 may comprise an attachment location for attachment of hollow structure 100-9 to a vehicle or the attachment of other vehicle components, including other hollow structures, thereto. In the above manner a single hollow structure 100-9 may integrate, either individually or in any combination thereof, fluid reservoirs, headlamp receptacles, a radiator frame, a fan shroud, a bumper, and attachment locations, and offer all the benefits of component integration.

In another feature of the invention, hollow structure 100 may comprise a front-end structure in combination with at least one separately formed hollow structure connected thereto. For example, as shown in FIG. 33, hollow structure 100-10 comprises a front-end structure used in combination with hollow structures 100-11 and 100-12 located along the fender inner panels. As shown hollow structures 100-11 and 100-12 comprise wall sections which preferably mate and connect with wall sections of hollow structure 100-10. More specifically, hollow structures 100-11 and 100-12 comprise a rectangular protrusion which fits into a mating receptacle of hollow structure 100-10 to comprise an interlock via an interference fit. Similar to hollow structure 100-9, a single hollow structure 100-10 may integrate, either individually or in any combination thereof fluid reservoirs, headlamp receptacles, a radiator frame, and attachment locations, and offer all the benefits of component integration.

In another feature of the invention, hollow structure 100 may comprise a front end structure with a platform configured to support, and preferably retain against free movement thereon, at least one vehicle hand repair tool. For example, as shown in FIG. 16, the exterior contour of a wall section 352 of hollow structure 100-13 comprises a platform 356 configured to support, and preferably retain against free movement thereon, at least one vehicle hand repair tool. Furthermore, the exterior contour of a wall section 353 of hollow structure 100-13 may comprise a platform 358 to hold hand cleaner 360. Furthermore, the exterior contour of a wall section 354 of hollow structure 100-13 may comprise a fan shroud 355. Furthermore, the interior contour of a wall section 362, 364 of hollow structure 100-13 may comprise cavities 363, 365 the entrance of which is provided by apertures 359 and 361, respectively, for containing vehicle fluids, such as washer fluid and/or antifreeze, for a reservoir Furthermore, the interior contour of wall section 366, 368 of hollow structure 100-13 may comprise filler tubes 367, 369. Furthermore, a wall section 370 of hollow structure 100-13 may comprise a cover 372 for platform 356.

As shown in FIG. 16, cover 372, or any other suitable vehicle component, may be formed in the center of fan shroud 355 in an initial position during the forming of hollow structure 100-13, then disconnected from the hollow structure 100-13, for example via cutting, and transferred to its final use position above platform 356. The center of the fan shroud, or any other cut-out area, ordinarily comprises a waste area region for material in the blow molding process. Thus, by forming the cover 372, or any other suitable vehicle component in a region which ordinarily comprises a cut-out waste area, the cover 372, or other component, is provided essentially for no cost.

In another feature of the invention, hollow structure 100 may comprise a front end structure with a movable access panel. For example, as shown in FIG. 17A, wall section 374 of hollow structure 100-14 comprises an access panel 376 disposed along the upper forward edge of the fan shroud 355 which may be rotatable from a closed position to an open position via a living hinge 378. Among other things, the access panel 376 may comprise a cover for the engine compartment aperture ordinarily located between the fascia or grille of the front of the vehicle and the radiator frame, thus providing a cleaner appearance of the engine compartment. The access panel 376 may also comprise a platform configured to support, and preferably retain against free movement thereon, at least one vehicle hand repair tool. Furthermore, by virtue of being movable from a closed position to an open position via a living hinge, the access panel 376 provides for attachment to the hollow structure 100-14, as well as access to vehicle components located there beneath, without requiring a separately formed hinge attached thereto.

In another feature of the invention, hollow structure 100 may also comprise an improved pinched region configuration which provides for improved stiffness. For example, as best shown in FIG. 15C, hollow structure 100-15 comprises an improved pinched region configuration 380 wherein the pinched region configuration is narrower than previously provided. Pinched region 380 comprises a thicker wall section 381, shown in partial cross-section, in a portion of the wall structure of the pinched region 380.

In another feature of the invention, hollow structure 100 may comprise a rear shelf (also known as a rear deck lid, package tray or parcel shelf). For example, as shown in FIG. 5A, the exterior contour of a wall section 392 of hollow structure 100-16 comprises a rear shelf 394. Furthermore, an interior contour of a wall section 390 of hollow structure 100-16 may comprise a cavity 391 the entrance of which is provided by apertures 400, for containing vehicle fluids, such as washer fluid for a reservoir. Furthermore, the exterior contour of a wall section 393 of hollow structure. 100-16 may comprise an attachment location 396 for a vehicle component, such as a speaker. Furthermore, the exterior contour of a wall section 392 of hollow structure 100-16 may comprise at least a partial cover for contents stored in a vehicle's rear cargo area 398.

The aperture 400 for filling cavity 391 of hollow structure 100-16 with fluid may be concealed from view when not in use. As shown in FIG. 5B, aperture 400 may be located in a vehicle's rear cargo area 398 and concealed when the rear cargo lid 402 (e.g. trunk lid, hatch-back door, lift-gate) is closed. In the above manner, features of hollow structure 100-16 include the improved utilization of existing packaging space, isolating the reservoir fill point away from the structure, use of the reservoir to isolate noise from audio speakers and the minimization of fluid freeze. Furthermore, benefits include component consolidation, simplified assembly and complexity, and centralizing vehicle mass.

In another feature of the invention, hollow structure 100 may comprise a step platform to support occupant entry and exit from the vehicle. For example, as shown in FIGS. 21A and 21B, the exterior contour of a wall section 406 of hollow structure 100-17 comprises a step platform 407 in the form of a running board. Furthermore, the interior contour of hollow structure 100-17 may comprise a cavity 404 for holding vehicle fluid, such as washer fluid for a reservoir.

The aperture 408 for filling cavity 404 of hollow structure 100-17 with fluid may be concealed from view when not in use. As shown in FIG. 21A, the aperture 408 may be located in a vehicle's engine compartment and concealed when the vehicle's hood is closed. In order to extend aperture 408 into the vehicle's engine compartment, hollow structure 100-17 may include a filler tube 410. Filler tube 410 may be formed with hollow structure 100-17, more may be attached to hollow structure 100-17 after formation thereof, for example, by welding (e.g. ultrasonic, vibration, hot-plate). In the above manner, features of the step platform include a lightweight structure to replace aluminum or injection molding and a structure which can be readily colored to accent or match vehicle color.

As shown in FIG. 21B, at least a portion of the wall structure defining cavity 404 and at least a portion of the wall structure comprising step platform 407 are comprised of at least partially the same wall structure. Furthermore, as shown in FIG. 21B, at least a portion of cavity 404 and at least a portion of step platform 407 are disposed on opposite sides of a same portion of the wall structure.

In another feature of the invention, hollow structure 100 may be connected to an interior trim component. For example, as shown in FIGS. 19A and 19B, hollow structure 100-18 is connected to an interior trim component in the form of a rear interior quarter panel 412. More specifically as shown in FIG. 19B, hollow structure 100-18 is connected to rear interior quarter panel 412 along at least a portion of the perimeter edge thereof. Hollow structure 100-18 may comprise a cavity 413 the entrance of which is provided by aperture 415, for containing fluid, such as washer fluid for a reservoir and may be connected to rear interior quarter panel 412 by welding (e.g. ultrasonic, vibration, hot-plate). In the above manner, features of hollow structure 100-18 include easy packaging of the reservoir and welding for lifetime connection.

In another feature of the invention, hollow structure 100 may be provided with an improved cover for covering an aperture configured for receiving contents into or withdrawing contents from the hollow structure 100. For example, as shown in FIG. 12A, hollow structure 100-19 is provided with an aperture 414 configured for receiving contents into or withdrawing contents from cavity 417 of hollow structure 100-19. A cover 416 is configured to cover aperture 414. Cover 416 includes an outer lip 418 and an inner lip 420. As shown, outer lip 418 and inner lip 420 comprise a closed loop, however, in other embodiments, either or both of the lips 418, 420 may form an intermittent loop.

Turning to FIG. 12B, when assembled to hollow structure 100-19, outer lip 418 surrounds the outer surface 424 of rim 422 of hollow structure 100-19 while inner lip 420 surrounds the inner surface 426 of rim 422 of hollow structure 100-19. In this manner, the inner lip 420 of cover 416 is configured as a splash guard to reduce contents from leaking over the top of rim 422 and from aperture 414 of hollow structure 100-19 during vehicle travel.

In another feature of the invention, hollow structure 100 may comprise a vehicle steering wheel. For example, as shown in FIGS. 13A and 13B, hollow structure 100-20 comprises a steering wheel 430. Furthermore, the exterior contour of a wall section 428 of hollow structure 100-20 may comprise the circular portion 434 of a steering wheel 430. Furthermore, the interior contour of wall section 428 of hollow structure 100-20 may comprise a cavity 429. Furthermore, the exterior contour of a wall section 432 of hollow structure 100-20 may comprise the hub portion 436 of steering wheel 430. Furthermore, the interior contour of wall section 432 of hollow structure 100-20 may comprise a cavity 431. Furthermore, the exterior contour if a wall section 433 of hollow structure 100-20 may comprise a receptacle 438 for a steering wheel hub 440. Steering wheel hub 440 may comprise an airbag and/or a horn mechanism. Furthermore, the exterior contour of a wall section 442 of hollow structure 100-20 may comprise a receptacle for a steering wheel insert or armature 444 which mates with the remainder of the steering mechanism, typically the steering shaft. In the above manner, features of hollow structure 100-20 include low mass and less column shake. Furthermore, the benefits include modular design which replaces steel stampings and castings.

In another feature of the invention, hollow structure 100 may comprise a lower seat frame. For example, as shown in FIG. 26A, hollow structure 100-21 comprises a lower seat frame 448. Furthermore, the exterior contour of a wall section 446 of hollow structure 100-21 may comprise a seat pan 450. Seat pan 450 may comprise a convex shape which is configured to provide shock absorption and resilient support to cushion vehicle ride while maintaining its convex shape (i.e. bowed outward) in response to a load applied thereto, such as the weight to a vehicle passenger thereon. Furthermore, the exterior contour of wall section 446 of hollow structure 100-21 may be covered with a cushion (e.g. foam) to comprise additional comfort. Furthermore, the exterior contour of a wall section 447 of hollow structure 100-21 may comprise at least one attachment location 452 for attaching the lower seat frame 448 to an upper seat frame 458. Furthermore, the exterior contour of a wall section 449 of hollow structure 100-21 may comprise at least one attachment location 454 for attaching the lower seat frame 448 to rails 456 which secure the lower seat frame 448 to the vehicle floor pan. Furthermore, the interior contour of wall sections 446, 447, 449 of hollow structure 100-21 may comprise a cavity 451 which contains air.

In another feature of the invention, hollow structure 100 may comprise an upper seat frame. For example, as shown in FIG. 26B, hollow structure 100-22 comprises an upper seat frame 458. Furthermore, the exterior of a wall section 460 of hollow structure 100-22 may comprise a back pan 462. Similar to seat pan 450, back pan 462 may also comprise a convex shape which is configured to provide shock absorption and resilient support to cushion vehicle ride while maintaining its convex shape in response to a load applied thereto, such as the weight to a vehicle passenger thereon. Furthermore, the exterior of wall section 460 of hollow structure 100-22 may be covered with a cushion 474 (e.g. foam) to comprise additional comfort. Furthermore, the exterior of a wall section 461 of hollow structure 100-22 may comprise at least one receptacle 464 for the incorporation of a seat component therein, such as diaphragm/bladder 466 for a lumbar system or massager. Furthermore, the exterior of a wall section 463 of hollow structure 100-22 may comprise at least one attachment location 468 for attaching the upper seat frame 458 to a lower seat frame 448. Furthermore, the exterior of a wall section 465 of hollow structure 100-22 may comprise at least one attachment location 472 for attaching a headrest 470 to the upper seat frame 458. Furthermore, the interior contour of wall sections 460, 461, 463, 465 of hollow structure 100-21 may comprise a cavity 453 which contains air. In the above manner, features of hollow structures 100-21 and 100-22 include ultra lightweight design, and use as modular stadium seating. Additionally, it is also possible to integrate electronic seat adjustment systems and molded-in mechanical components as well as a pressed on seat cushion. Furthermore, the benefits include unified tooling across the vehicle line resulting in low cost and increased value.

In another feature of the invention, hollow structure 100 may comprise a mirror housing. For example, as shown in FIG. 30, hollow structure 100-23 comprises a mirror housing 478 for a side view mirror 480. Furthermore, an exterior contour of a wall section 476 of hollow structure 100-23 may comprise an attachment location 482 for attaching the mirror adjustment mechanism 484 to the mirror housing 478. Furthermore, an exterior contour of a wall section 477 of hollow structure 100-23 may comprise an attachment location 486 for attaching the mirror housing 478 to a vehicle. Furthermore, an interior contour of wall sections 476, 477 may comprise a cavity 479. In the above manner, features of hollow structure 100-23 include a stiffer design with loss costly material and the ability to package automatic mirror components. Furthermore, benefits include low vibration and high packaging content for motors, heaters and extensions.

In another feature of the invention, hollow structure 100 may comprise a lower duct in a vehicle's passenger compartment. For example, as shown in FIG. 9A, hollow structure 100-24 comprises a lower duct 492. Furthermore, the exterior contour of wall sections of hollow structure 100-24 may comprise an A-pillar portion 494, a door sill portion 496 and a B-pillar portion 498, while the interior contour of the same wall sections of hollow structure 100-24 comprise a cavity 497. A-pillar portion 494, a door sill portion 496 and a B-pillar portion 498 of hollow structure 100-24 preferably cover corresponding portions of the A-pillar, door sill and B-pillar of the vehicle body, respectively. Hollow structure 100-24 may be in fluid communication with at least one additional duct 506 extending from the vehicle's instrument panel as to receive air there from. Hollow structure 100-24 may comprise at least one outlet for distributing air into the passenger compartment. As shown, hollow structure 100-24 comprises one outlet 500 located on the A-pillar portion for directing air towards the front seat occupants. Also as shown, hollow structure 100-24 comprises two outlets 502, 504 for directing air towards the feet and head of a rear seat occupant. In the above manner, features of hollow structure 100-24 include a single component used both for an interior trim panel and channels for heating and cooling. In addition, the ducting can be textured and/or painted to simulate a variety of trim schemes and patterns and may be used for routing of electrical wiring and washer hose. Furthermore, one can attach assist handles, coat hooks, trays, and speakers. Furthermore, the benefits include modular assembly and easy servicing.

In another feature of the invention, hollow structure 100 may comprise an upper duct in a vehicle's passenger compartment. For example, as shown in FIG. 8A, hollow structure 100-25 comprises an upper duct 510. Furthermore, the exterior contour of wall sections of hollow structure 100-25 may comprise a left-side A-pillar to B-pillar roof rail portion 512, a left-side B-pillar to C-pillar roof rail portion 514, a right-side A-pillar to B-pillar roof rail portion 516, a right-side B-pillar to C-pillar roof rail portion 518, and a left-side B-pillar to right-side B-pillar cross-car portion 520, while the interior contour of the same wall sections of hollow structure 100-25 comprise a cavity 525. Left-side A-pillar to B-pillar roof rail portion 512, a left-side B-pillar to C-pillar roof rail portion 514, a right-side A-pillar to B-pillar roof rail portion 516, a right-side B-pillar to C-pillar roof rail portion 518, and a left-side B-pillar to right-side B-pillar cross-car portion 520 preferably cover corresponding portions of the roof rails and cross-car of the vehicle body, respectively. Hollow structure 100-25 is preferably is in fluid communication with at least one additional duct 522 located in the A-pillar as to receive air extending from the vehicle's instrument panel. Hollow structure 100-25 may comprise at least one outlet for distributing air into the passenger compartment. As shown, hollow structure 100-25 comprises at least one outlet 524 located on a roof rail portion and at least one outlet 526 located on the cross-car portion. Similar to hollow structure 100-24, features of hollow structure 100-25 include a single component used both for an interior trim panel and channels for heating and cooling. In addition, the ducting can be textured and/or painted to simulate a variety of trim schemes and patterns and may be used for routing of electrical wiring and washer hose. Furthermore, one can attach assist handles, coat hooks, trays, and speakers. Furthermore, the benefits include integration into the headliner, modular assembly and easy servicing.

In another feature of the invention, hollow structure 100 may comprise a fuel tank. For example, as shown in FIG. 4A, the interior contour of a wall section of hollow structure 100-26 comprises a cavity 528 which comprises a fuel tank for holding gasoline or diesel. Furthermore, the interior contour of a wall section of hollow structure 100-26 comprises a cavity 530 which comprises a reservoir for holding vehicle fluid, such as washer fluid. As such, preferably cavities 528, 530 are isolated from one another such that the individual fluids contained within cavities 528, 530 remain separated after entry into the cavities 528, 530 and do not mix. In addition to comprising at least two fluid cavities, each cavity 528, 530 of hollow structure 100-26 may comprise at least one filler tube 532, 534, respectively.

Cavity 530 may at least partially surrounds the perimeter of cavity 528 along the perimeter edge thereof. As shown in FIG. 4A, cavity 530 substantially surrounds the perimeter of cavity 528, but in other embodiments may completely surround the perimeter cavity 528. In this manner, when the vehicle is impacted in the event of a collision, cavity 528 may be protected from puncture or other types of perforations by cavity 530. Given that cavity 530 is more apt to be impacted, and potentially punctured, than cavity 528 by virtue of its location closer to the perimeter of the vehicle, preferably cavity 530 is filled with a non-flammable fluid such as washer fluid. In still other embodiments, cavity 530 may be filled with an extinguishing fluid, such as carbon dioxide, to aid in extinguishing any flammable fluid from cavity 528 in the event of ignition.

Wall sections for cavities 528, 530 may be joined, as well as their respective cavities 528, 530 separated, along a pinched region 536 in which a first wall section 538 and second wall section 540 extend inwards towards the interior confines of the hollow structure 100-26 and are bonded. The first wall section 538 and second wall section 540 may be thermally bonded, and more particularly autogenicly bonded, during the formation of hollow structure 100-26. In the above manner, the features of hollow structure 100-26 include simplified reservoir packaging (i.e. packaging multiple reservoirs in a single hollow structure), the addition of more engine compartment space (i.e. removal of the washer fluid from the engine compartment to beneath the vehicle), central mass distribution beneath the vehicle, isolation of washer pump motor noise away from the engine compartment and the minimization of washer fluid freeze. Furthermore, additional benefits include component consolidation, zero fastener addition, lower visual material requirements and the potential to commonize designs across different vehicles.

In another feature of the invention, hollow structure 100 may comprise a spare wheel holder. For example, the exterior contour of a wall section 550 of hollow structure 100-27 comprises spare wheel holder 552, in the form of a spare wheel well. Furthermore, the exterior contour of a wall section 554 of hollow structure 100-27 may comprise a filler tube 556. Furthermore, the exterior contour of a wall section 558 of hollow structure 100-27 may comprise a cover 560 for spare wheel holder 552. Furthermore cover 560 may comprise a rear cargo area load floor for a vehicle. Furthermore, a wall section 562 of hollow structure 100-27 may comprise a living hinge for rotating cover 560 from a closed position overlying spare wheel holder 552 to an open position where a wheel or other contents in wheel holder 552 may be removed. Furthermore, an exterior contour of a wall section 564 of hollow structure 100-27 may comprise a platform 566 configured to support, and preferably retain against free movement thereon, at least one vehicle hand repair tool. Furthermore, an exterior contour of a wall section 568 of hollow structure 100-27 may comprise a cover 570 for platform 566. Furthermore, a wall section 572 of hollow structure 100-27 may comprise a living hinge for rotating cover 570 from a closed position overlying platform 566 to an open position where contents stored beneath cover 570 may be removed. Furthermore, the interior contour of wall section 550 of hollow structure 100-26 may comprise a cavity 574 disposed beneath spare wheel holder 552 which comprises a fuel tank for holding gasoline or diesel. Features of hollow structure 100-27 include a single structure used to hold a donut spare, along with a jack and safety items. In addition, hollow structure 100-27 includes a centralized fluid fill and isolation of pump noise from the vehicle passengers. Furthermore, the benefits include component consolidation and modular design used across several platforms.

As shown in FIG. 22B, at least a portion of the wall structure defining cavity 574 and at least a portion of the wall structure comprising spare wheel holder 552 are comprised of at least partially the same wall structure. Furthermore, as shown in FIG. 22B, at least a portion of cavity 574 and at least a portion of spare wheel holder 552 are disposed on opposite sides of a same portion of the wall structure.

In another feature of the invention, two or more hollow structures 100 may be used in combination with and connected to each other. For example, as shown in FIG. 25A, hollow structure 100-28 and hollow structure 100-29 are connected to one another by an interlocking configuration in which each structure itself comprised a portion of the configuration forming the interlock. As shown in FIG. 25B, hollow structure 100-29 comprises a first portion of the interlock in the form of at least one elongated protrusion 580. While FIGS. 100-29 only illustrates one elongated protrusion 580, a second protrusion is located on the opposite side of hollow structure 100-29. As shown in FIG. 25A, hollow structure 100-28 comprises a second portion of the interlock in the form of at least one elongated receptacle 582. As shown there are two elongated receptacles which extend from the top of hollow structure 100-28 towards the bottom of hollow structure 100-28. An interlock between hollow structure 100-29 and hollow structure 100-28 may be formed by sliding each elongated protrusion 580 of hollow structure 100-29 within elongated receptacle 582 of hollow structure 100-29 from the top of hollow structure 100-28 towards the bottom of hollow structure 100-29. In this manner a mechanical engagement is formed between hollow structures 100-28 and 100-29 which resists separation of the two structures in at least one direction other then the direction in which the two structures were joined.

As shown hollow structure 100-28 comprises a fuel tank, while hollow structure 100-29 comprises a reservoir for holding washer fluid. Each hollow structure 100-28, 100-29 may comprise separately formed and attached filler tubes 584, 586, respectively. Furthermore, each hollow structure 100-28, 100-29 may include one or more pumps attached thereto for withdrawing fluid from the structures. In the above manner, features of the hollow structure combination 100-28, 100-29 include simplified reservoir packaging, and the addition of more engine compartment space (i.e. removal of the washer fluid from the engine compartment to beneath the vehicle). In addition, features include central mass distribution and isolates the pump motor noise away from the engine compartment and minimization of fluid freeze. Furthermore, the benefits include component consolidation, zero fastener addition, lower visual material requirements and the potential to commonize designs across different vehicles.

In another feature of the invention, hollow structure 100 may comprise a door arrangement. In other words, an arrangement which is part of a door assembly. For example, as shown in FIG. 28, hollow structure 100-30 comprises a door arrangement 590 which is part of a rear door assembly 592, specifically a tailgate hinged about its lower edge. Furthermore, the exterior contour of a wall section 594 of hollow structure 100-30 may comprise a spare wheel holder 596, in the form of a spare wheel well. Furthermore, the exterior contour of a wall section 598 of hollow structure 100-30 may comprise a jack holder 600. Furthermore, the exterior contour of a wall section 602 of hollow structure 100-30 may comprise a jack holder cover 604. Furthermore a wall section 606 of hollow structure 100-30 may comprise a living hinge between jack holder 600 and jack holder cover 604. Furthermore, an exterior contour of a wall section 608 of hollow structure 100-30 may comprise a tool holder 610. Furthermore, the exterior contour of a wall section 612 of hollow structure 100-30 may comprise a tool holder cover 614. Furthermore a wall section 616 of hollow structure 100-30 may comprise a living hinge between tool holder 610 and tool holder cover 614. Furthermore, an interior contour of a wall section 618 of hollow structure 100-30 may comprise a cavity 620, the entrance of which is provided by aperture 621, which comprises a reservoir for vehicle fluids, such as washer fluid. In the above manner, features of hollow structure 100-30 include storage of the spare tire, jack and other tools, more convenient access, and a rear tailgate reservoir. Furthermore, the benefits include the use of unclaimed vehicle space, the ability to comprise for a larger fuel tank and the ability to be offered as a vehicle option. Furthermore, the various containers of hollow structure face inwards towards the interior of the vehicle when the door assembly 592 is in its closed position and are accessed when the door assembly is in its opened position.

In another feature of the invention, hollow structure 100 may comprise a door arrangement in which various holders of the hollow structure face outwards away from the vehicle when the door assembly is closed, and which may accessed from the outside of the vehicle when the hollow structure remains in its closed position. For example, as shown in FIG. 27, the various holders of the hollow structure 100-31 face outwards away from the vehicle when the door assembly is closed (spare wheel holder 624, jack holder 626, tool holder 628, cavity 639, the entrance of which is provided by aperture 629, to a fluid reservoir) and are accessed from the outside of the vehicle when the hollow structure remains in its closed position via an opening created with the outer body panel 622. Furthermore, outer body panel 622 may comprise a cover for the various holders of hollow structure 100-31 when outer body panel 622 is in its closed upright position. Furthermore, the exterior contour of a wall section of hollow structure 100-31 may comprise a lamp holder 632 for a center high mount stop lamp (CHMSL). Similar to hollow structure 100-30, features of hollow structure 100-31 include storage of the spare tire, jack and other tools, more convenient access, a rear tailgate reservoir. Hollow structure 100-31 also comprises integration of the rear center high mount safety light (CHMSL). Furthermore, the benefits include the use of unclaimed vehicle space, the ability to comprise for a larger fuel tank and the ability to be offered as a vehicle option.

In another feature of the invention, hollow structure 100 may comprise a door arrangement which is at least partially covered by an interior trim panel. For example, as shown in FIG. 3A, hollow structure 100-32 is at least partially covered on the inside of the vehicle by an interior trim panel 634 and on the outside by an exterior trim or body panel 636. Furthermore, the interior contour of a wall section 635 of hollow structure 100-32 may comprise a cavity 637 which comprises a reservoir for vehicle fluids, such as washer fluid. Features of hollow structure 100-32 include forming various holders directly into existing vehicle space. The benefits include offering such tailgate as an option and a minimal cost addition.

In another feature of the invention, hollow structure 100 may comprise a spare wheel mounting bracket for storing a spare wheel thereon. For example, as shown in FIG. 29, the exterior contour of a wall section of hollow structure 100-33 comprises a spare wheel holder 638, in the form of a spare tire mounting bracket, attached to the vehicle adjacent an outer body panel of the rear door assembly for mounting and storing a spare wheel 640 thereon. Furthermore, the exterior contour of a wall section of hollow structure 100-33 may comprise a lamp holder 642 for a center high mount stop lamp (CHMSL). Furthermore, the interior contour of a wall section of hollow structure 100-33 may comprise a cavity 641. In the above manner, features of hollow structure 100-33 include a modular design that integrates the CHMSL and spare wheel holder.

In another feature of the invention, hollow structure 100 may comprise corresponding left-side and a right-side vehicle components formed simultaneously. For example, as shown in FIG. 18A, the exterior contour of a wall section of hollow structure 100-34 comprises trim components in the form of a left-side interior trim panel 644 and the same corresponding right-side interior trim panel 646 formed inner surface to inner surface. Furthermore, the interior contour of the wall section of hollow structure 100-34 comprising left-side interior trim panel 644 and right-side interior trim panel 646 comprises a cavity 647. After formation, the left-side interior trim panel 644 and the right-side interior trim panel 646 are trimmed from hollow structure 100-34 along a trim line 648 to form the finished panels 644 and 646. Features of hollow structure 100-34 include the providing of a left-side and a right-side component simultaneously from a single formed part. The benefits include component consolidation and lower production cost.

In another feature of the invention, hollow structure 100 may comprise an engine cover. For example, as shown in FIG. 1A, the exterior contour of a wall section 650 of hollow structure 100-35 comprises an engine cover 651, particularly a valve cover. Furthermore, the interior contour of wall section 650 of hollow structure 100-35 may comprise a cavity 649. Furthermore, the interior contour of a wall section 652 may comprise a cavity 653 forming an air filter housing 655. Furthermore, the exterior contour of a wall section 654 may comprise a duct for providing the air filter housing 655 with air. Features of hollow structure 100-35 include an engine cover, air filter housing, air intake hose, and oil filler tube in a single component. In addition, features of hollow structure 100-35 also include a textured surface, a high tech look, a tuned airflow/inlet, easy access to the oil fill and air filter, and a formed shape to match the hood line. Furthermore, benefits include component consolidation, simplification of assembly complexity and lower vehicle mass.

In another feature of the invention, hollow structure 100 may comprise a battery housing. As shown in FIG. 32, the exterior contour of a wall section 666 of hollow structure 100-36 comprises a battery housing 676. Furthermore, the exterior contour of a wall section 668 of hollow structure 100-36 may comprise a fuse housing 678. Furthermore, the exterior contour of a wall section 670 of hollow structure 100-36 may comprise a filter housing 680, such as for an air filter. Furthermore, the exterior contour of a wall section 672 of hollow structure 100-36 may comprise a cover 682 for the filter housing. Furthermore, a wall section 674 of hollow structure may comprise a living hinge between the filter housing 680 and the cover 682 for the filter housing. Features of hollow structure 100-36 include clean packaging and the ability to contain both the battery and ECM/fuse modules in the same structure. Furthermore, since battery housing 676, fuse housing 678, filter housing 680 and cover 682 comprise a double wall construction with corresponding cavities disposed between their wall sections, washer fluid or another suitable fluid may be provided in the cavities between the double wall construction to insulate and/or cool or heat items contained in the housings. Furthermore, the benefits include simplified electrical connection and maintenance.

In another feature of the invention, hollow structure 100 may comprise an air conditioning housing. For example, as shown in FIG. 20, the exterior contour of a wall section of hollow structure 100-37 comprises an air conditioning housing 684. Furthermore, the interior contour of a wall section of hollow structure 100-37 may comprise a cavity 686 forming a reservoir for holding vehicle fluid. Features of hollow structure 100-37 include a modular unit that is easily packaged.

In another feature of the invention, hollow structure 100 may comprise a floor pan. For example, as shown in FIG. 11A, the exterior contour of a wall section 690 of hollow structure 100-38 comprises a floor pan 692. Furthermore, the exterior contour of a wall section 694 of hollow structure 100-38 may comprise a seat attachment location 696. Furthermore, the exterior contour of a wall section 698 of hollow structure 100-38 may comprise a cover 700 for a reservoir. Furthermore, the interior contour of the wall section 690 of hollow structure 100-38 may comprise a cavity 691. Cavity 691, as well as any other of the cavities disclosed herein, may be filled with a sound attenuating material (e.g. plastic foam, textile, spheres) in order for the floor pan 692 to achieve increased sound attenuation. In the above manner, the features include a floor pan used to attenuate noise and vibration between interior and exterior regions of the vehicle. Furthermore, some sections of the floor pan, such as cavity 691, can be used as reservoirs for vehicle fluids. The benefits of the floor pan include left side and right side panels being formed in one step and textured parts used in commercial and utility vehicles. As shown in FIG. 11A, at least a portion of the wall structure defining cavity 691 and at least a portion of the wall structure comprising floor pan 692 are comprised of at least partially the same wall structure. Furthermore, as shown in FIG. 11A, at least a portion of cavity 691 and at least a portion of floor pan 692 are disposed on opposite sides of a same portion of the wall structure.

In another feature of the invention, hollow structure 100 may comprise a fluid reservoir for location on the B-pillar of a vehicle. For example, as shown in FIG. 11B, the interior contour of a wall section of hollow structure 100-39 comprises a cavity 702 for holding vehicle fluids, such as washer fluid, for a reservoir for location on the B-pillar of a vehicle.

In another feature of the invention, hollow structure 100 may comprise a step platform to support occupant entry and exit from the vehicle. For example, as shown in FIG. 11C, the exterior contour of a wall section 704 of hollow structure 100-40 comprises a step platform 706 in the form of a step well. Furthermore, the interior contour of a wall section of hollow structure 100-40 may comprise a cavity 708 for holding vehicle fluid for a reservoir.

In another feature of the invention, hollow structure 100 may comprise an interior engine cowl. For example, as shown in FIG. 11D, the exterior contour of a wall section 708 of hollow structure 100-41 comprises an engine cowl 710. Furthermore, an exterior contour of a wall section 712 of hollow structure 100-41 may comprise an attachment location 714 for a trim panel cover 716.

In another feature of the invention, hollow structure 100 may comprise a vacuum reservoir. As shown in FIG. 10, hollow structure 100-42 comprises a cavity 718 for containing a vacuum. Features of hollow structure 100-42 include the ability to use across several vehicle platforms. The benefits include a single piece construction that replaces several assembled injection moldings in a pressurized system.

Hollow structures 100 to 100-42 have been shown and described throughout this specification. It should be understood that while some of the features of the various hollow structures disclosed within this specification may apply to different end-use applications, the various features of a particular hollow structure disclosed within may be used alone, or in combination with any feature(s) of any other hollow structure(s) disclosed within, as would be recognized by one reasonably skilled in the art.

Hollow structure 100 (collectively including hollow structures 100-1 to 100-42 above) is preferably formed from plastic using a blow molding process. Hollow structure 100 is preferably sufficiently rigid to be self-supporting (i.e. maintain its molded shape under its own weight) upon installation and with use in the vehicle. An exemplary plastic material comprises a thermoplastic such as polypropylene. Other plastics may include other olefins such as polyethylene. Accordingly, plastics material suitable herein include those plastic resins suitable for blow-molding that exhibit a tensile or flexural modulus value above 150,000 psi (1050 MPa). Along such lines, a particular preferred material would be high density polyethylene (HDPE), with a tensile or flexural modulus of about 200,000 psi (1400 MPa). Other suitable plastics include polyethylene and/or polypropylene copolymers, poly(vinyl chloride), low density polyethylene (LDPE), ethylene-vinylacete copolymers (EVA), linear low density polyethylene, and polyethylene terephthalate (PET). Reference therefore is made to “Blow Molding Handbook”, Rosato & Rosato (Hanser 1989) for a complete list of those resins suitable for the blow molding operation herein.

Blow molding may be accomplished by providing a molten parison, generally in the shape of a hollow tube, between two halves of an open split mold, then inflating the parison as to expand it against the surfaces of the closed mold via air pressure. Typically, the parison is formed by either extrusion or injection molding. Where the parison is extruded, typically it is inflated immediately thereafter. However, where the parison is injection molded, it may be cooled for storage, then reheated at a subsequent time thereafter before blowing.

Generally an extruded parison is open ended at the lower end thereof, as opposed to an injection molded parison which is generally close ended. As the extruded parison, extends downward between the open mold halves, the mold begins to close when the parison has reached an appropriate length. During the extrusion of the parison, air may be injected through the interior of the open ended parison to prevent collapse of the parison and associated adhesion of its wall sections to one another. During mold closure, a portion of the mold ordinarily seals or welds the open end of an open ended parison closed so that air subsequently injected into the parison is trapped within the interior of the parison. The subsequent build up or increase in air pressure within the parison forces the parison to stretch and expand against the surfaces of the closed mold. Thereafter, the plastic is cooled, the mold is opened and the hollow structure removed from the mold cavity.

Alternatively, the extruded parison may be sealed by pincers or other similar apparatus before the mold is closed, rather than simultaneously, and “preblown” with a small amount of air. Preblowing may be desirable to increase the uniformity of the wall thickness distribution of the parison.

Blow molding is the preferred method for providing hollow structures 100 to 100-42 given that blow molding can provide a plastic structure with an interior cavity formed within the confines of a unitary wall structure. In the case where the application is that of a fluid reservoir, a unitary wall structure is preferred over a non-unitary wall structure to reduce the potential for leakage from the reservoir.

Examples of other plastic processes which can provide hollow structures 100 to 100-42 include rotational molding (also known as rotomolding and rotational casting) and gas-assisted injection molding. However, blow molding of hollow structures 100 to 100-42 is preferred over rotational molding given the longer cycle times associated with rotational molding. Furthermore, blow molding of hollow structures 100 to 100-42 is preferred over gas-assisted injection molding as the interior cavity produced in gas-assisted injection molding has a significantly smaller volume capability than the interior cavities which may be produced with blow molding.

We intend the above description to illustrate the hollow structures 100 to 100-42 by using descriptive rather than limiting words. Obviously, there are many ways that one might modify the structures and methods while remaining within the scope of the claims. In other words, there are many other ways that one may practice the present inventions without exceeding the scope of the claims.

We claim:

1. A plastic structure for a motor vehicle comprising:
a wall structure;
at least a portion of the wall structure having an interior contour defining at least one interior cavity (206) formed within the wall structure; and
at least a portion of the wall structure having an exterior contour comprising a battery holder (208), the battery holder (208) comprising a platform (210) to support a battery.

2. The plastic structure of claim 1 wherein at least a portion of the wall structure defining the interior cavity (206) and at least a portion of the wall structure comprising the battery holder (208) are comprised of at least partially the same wall structure.

3. The plastic structure of claim 1 wherein at least a portion of the interior cavity (206) and at least a portion of the battery holder (208) are disposed on opposite sides of a same portion of the wall structure.

4. The plastic structure of claim 1 wherein the interior cavity (206) comprises a reservoir for containing a fluid.

5. A plastic structure for a motor vehicle comprising:
a wall structure;
at least a portion of the wall structure having an interior contour defining at least one interior cavity (230) formed within the wall structure; and
at least a portion of the wall structure having an exterior contour comprising a cable guide (220), the cable guide (220) comprising an elongated recess formed into the wall structure.

6. The plastic structure of claim 5 wherein at least a portion of the wall structure defining the interior cavity (230) and at least a portion of the wall structure comprising the cable guide (220) are comprised of at least partially the same wall structure.

7. The plastic structure of claim 5 wherein at least a portion of the interior cavity (230) and at least a portion of the cable guide (220) are disposed on opposite sides of a same portion of the wall structure.

8. The plastic structure of claim 5 wherein the interior cavity (230) comprises a reservoir for containing a fluid.

9. A plastic structure for a motor vehicle comprising:
a wall structure;
at least a portion of the wall structure having an interior contour defining at least one interior cavity (272) formed within the wall structure; and
at least a portion of the wall structure having an exterior contour comprising a wheel well liner (274) for the motor vehicle.

10. The plastic structure of claim 9 wherein at least a portion of the wall structure defining the interior cavity (272) and at least a portion of the wall structure comprising the wheel well liner (274) are comprised of at least partially the same wall structure.

11. The plastic structure of claim 9 wherein at least a portion of the interior cavity (272) and at least a portion of the wheel well liner (274) are disposed on opposite sides of a same portion of the wall structure.

12. A plastic structure for a motor vehicle comprising:
a wall structure;
at least a portion of the wall structure having an interior contour defining at least one interior cavity (287) formed within the wall structure; and
at least a portion of the wall structure connected to the underside of a hood of the motor vehicle.

13. The plastic structure of claim 12 wherein the interior cavity (287) comprises a reservoir for containing a fluid.

14. An access panel (298) disposed adjacent the forward lower edge (294) of a windshield (296) for a motor vehicle, the access panel (298) movable from a closed position to an open position to provide access to components located beneath the access panel.

15. A plastic structure for a motor vehicle comprising:
a wall structure;
at least a portion of the wall structure having an interior contour defining at least two interior cavities (316, 318) formed within the wall structure; and
at least a portion of the wall structure connected within an engine compartment of the motor vehicle adjacent the firewall.

16. The plastic structure of claim 15 wherein the plastic structure is concealed by an access panel (322), the access panel (322) movable from a closed position to an open position to provide access to the plastic structure.

17. A plastic structure for a motor vehicle comprising:
a wall structure;
at least a portion of the wall structure having an interior contour defining at least one interior cavity (326) formed within the wall structure; and
at least a portion of the wall structure having an exterior contour comprising a headlamp receptacle (334).

18. A plastic structure for a motor vehicle comprising:
a wall structure;
at least a portion of the wall structure having an interior contour defining at least one interior cavity (326) formed within the wall structure; and
at least a portion of the wall structure having an exterior contour comprising a radiator support frame (340).

19. A plastic structure for a motor vehicle comprising:
a wall structure;
at least a portion of the wall structure having an interior contour defining at least one interior cavity (326) formed within the wall structure;
at least a portion of the wall structure having an exterior contour comprising a radiator support frame (340);
at least a portion of the wall structure having an exterior contour comprising a fan shroud (342); and
at least a portion of the wall structure having an exterior contour comprising a bumper (346).

20. A plastic structure for a motor vehicle comprising:
a wall structure;
at least a portion of the wall structure having an interior contour defining at least one interior cavity (363) formed within the wall structure;
at least a portion of the wall structure having an exterior contour comprising a fan shroud (355); and
at least a portion of the wall structure having an exterior contour comprising a platform (356) configured to support at least one vehicle tool.

21. A plastic structure for a motor vehicle comprising:
a wall structure;
at least a portion of the wall structure having an interior contour defining at least one interior cavity (363) formed within the wall structure;
at least a portion of the wall structure having an exterior contour comprising a fan shroud (355); and
at least a portion of the wall structure comprising an access panel (376), the access panel (376) disposed along the upper forward edge of the fan shroud (355), the access panel (376) movable from a closed position to an open position to provide access to vehicle components located beneath the access panel (376).

22. A plastic structure for a motor vehicle comprising:
a wall structure;
at least a portion of the wall structure having an interior contour defining at least one interior cavity (391) formed within the wall structure; and
at least a portion of the wall structure having an exterior contour comprising a rear shelf (394).

23. A plastic structure for a motor vehicle comprising:
a wall structure;
at least a portion of the wall structure having an interior contour defining at least one interior cavity (404) formed within the wall structure; and
at least a portion of the wall structure having an exterior contour comprising a step platform (407).

24. A plastic structure for a motor vehicle comprising:
a wall structure;
at least a portion of the wall structure having an interior contour defining at least one interior cavity (413) formed within the wall structure; and
at least a portion of the wall structure connected to an interior trim component (412).

25. A plastic structure for a motor vehicle comprising:
a wall structure;
at least a portion of the wall structure having an interior contour defining at least one interior cavity (417) formed within the wall structure;
an aperture (414) formed in the wall structure configured to provide access to the interior cavity (417), the aperture (414) surrounded by a rim (422) formed in the wall structure; and
a cover (416) for the aperture (414), the cover (416) having an inner lip (420) and an outer lip (418), the outer lip (418) disposed around an outer surface (424) of the rim (422) and the inner lip (420) disposed around an inner surface (426) of the rim (422).

26. A plastic structure for a motor vehicle comprising:
a wall structure;
at least a portion of the wall structure having an interior contour defining at least one interior cavity (429) formed within the wall structure; and
at least a portion of the wall structure having an exterior contour comprising a steering wheel (430).

27. A plastic structure for a motor vehicle comprising:
a wall structure;
at least a portion of the wall structure having an interior contour defining at least one interior cavity (451) formed within the wall structure; and
at least a portion of the wall structure having an exterior contour comprising a lower seat frame (448), the lower seat frame (448) comprising a seat pan (450), the seat pan (450) comprising a convex shape and configured to provide resilient support in response to an load applied thereto.

28. A plastic structure for a motor vehicle comprising:
a wall structure;
at least a portion of the wall structure having an interior contour defining at least one interior cavity (453) formed within the wall structure; and
at least a portion of the wall structure having an exterior contour comprising an upper seat frame (458), the upper seat frame (458) comprising a back pan (462), the back pan (462) comprising a convex shape and configured to provide resilient support in response to an load applied thereto.

29. A plastic structure for a motor vehicle comprising:
a wall structure;
at least a portion of the wall structure having an interior contour defining at least one interior cavity (479) formed within the wall structure; and
at least a portion of the wall structure having an exterior contour comprising a mirror housing (478).

30. A plastic structure for a motor vehicle comprising:
a wall structure;
at least a portion of the wall structure having an interior contour defining at least one interior cavity (497) formed within the wall structure; and
at least a portion of the wall structure having an exterior contour comprising a duct (492), the duct comprising an A-pillar portion (494), a door sill portion (496) and a B-pillar portion (498).

31. A plastic structure for a motor vehicle comprising:
a wall structure;
at least a portion of the wall structure having an interior contour defining at least one interior cavity (525) formed within the wall structure; and
at least a portion of the wall structure having an exterior contour comprising a duct (510), the duct comprising a vehicle left-side roof rail portion (512), a vehicle right-side roof rail portion (516) and a vehicle cross-car portion (520).

32. A plastic structure for a motor vehicle comprising:
a wall structure;
at least a portion of the wall structure having an interior contour defining at least a first interior cavity (528) and a second interior cavity (530) formed within the wall structure; and
the first interior cavity (528) comprising a reservoir for containing a first fluid, the first fluid comprising a fuel for the motor vehicle.

33. A plastic structure for a motor vehicle comprising:
a wall structure;
at least a portion of the wall structure having an interior contour defining at least one interior cavity (574) formed within the wall structure; and
at least a portion of the wall structure having an exterior contour comprising a spare wheel holder (552).

34. A plastic structure for a motor vehicle comprising:
a wall structure;
at least a portion of the wall structure having an interior contour defining at least one interior cavity (620) formed within the wall structure; and
at least a portion of the wall structure having an exterior contour comprising a door arrangement (590);
at least a portion of the wall structure having an exterior contour comprising a spare wheel holder (596).

35. A plastic structure for a motor vehicle comprising:
a wall structure;
at least a portion of the wall structure having an interior contour defining at least one interior cavity (620) formed within the wall structure;
at least a portion of the wall structure having an exterior contour comprising a door arrangement (590); and
the cavity comprising a reservoir for holding fluid.

36. A plastic structure for a motor vehicle comprising:
a wall structure;
at least a portion of the wall structure having an interior contour defining at least one interior cavity (641) formed within the wall structure; and
at least a portion of the wall structure having an exterior contour comprising a spare wheel holder (638), the spare wheel holder (638) attached to the motor vehicle adjacent an outer body panel.

37. A plastic structure for a motor vehicle comprising:
a self-supporting wall structure;
at least a portion of the wall structure having an interior contour defining at least one interior cavity (647) formed within the wall structure;
at least a portion of the wall structure having an exterior contour comprising a vehicle left-side trim component (644) and a vehicle right-side trim component (646).

38. A plastic structure for a motor vehicle comprising:
a wall structure;
at least a portion of the wall structure having an interior contour defining at least one interior cavity (691) formed within the wall structure;
at least a portion of the wall structure having an exterior contour comprising a floor pan (692).
